(19) United States
(12) Patent Application Publication
(10) Pub. No.: US 2011/0025039 A1
(43) Pub. Date: Feb. 3, 2011

(54) METHOD AND APPARATUS FOR MAKING A SECTIONED TAB PRODUCT

(75) Inventor: Steven E. WELKER, Lykens, PA (US)

Correspondence Address: MCNEES WALLACE & NURICK LLC, 100 PINE STREET, P.O. BOX 1166, HARRISBURG, PA, 17108-1166, US

(73) Assignee: Manugraph DGM, Inc., Millersburg, PA (US)

(21) Appl. No.: 12/846,157

(22) Filed: Jul. 29, 2010

Related U.S. Application Data
(60) Provisional application No. 61/230,808, filed on Aug. 3, 2009.

(51) Int. Cl. B42D 15/00; B31F 1/00

(52) U.S. Cl. 283/62; 493/405

(57) ABSTRACT

A sectioned, folded tabloid paper product having a plurality of sections, the sections each having an independent number of pages. The paper product includes a mechanically formed first fold perpendicular to web travel, and a mechanically formed second fold parallel to web travel. The paper product includes a tabloid format that is formed on press. An apparatus for forming a sectioned, folded tabloid paper product is also disclosed.

### FIELD OF THE INVENTION

The disclosure relates to a device and method for creating folded paper products. More particularly, the disclosure includes a sectioned tab product, a method and an apparatus for forming a sectioned tab product.

### BACKGROUND OF THE INVENTION

With the increased prevalence of television, internet and other media outlets, the printing industry has been faced with increased competition and pressure to cut costs. As a result of this pressure, there is a desire for paper media, such as newspapers, to go to smaller formats to reduce paper consumption and provide customers with the products and formats that they desire. However, configuring for smaller formats requires expensive equipment and additional operational challenges.

One attempt to provide a format smaller than traditional broadsheet format is the “Berliner” format having an 18.5 inch cutoff. The Berliner format allows for the production of sectioned, broadsheet products in a much smaller, user-friendly size. In addition, the Berliner format provides significant paper/cost savings for publishers (12-16%, depending on the publisher's previous cutoff). However, this format suffers from the drawback that Berliner format paper products can only be manufactured by large, double circumference, expensive presses. In addition, the utilization of the Berliner format results in a fixed cutoff size, that is inflexible and does not permit adjustments.

Another attempt at providing reduced paper consumption is conversion of existing equipment into shorter cutoffs, so as to save paper and/or costs. One attempt at press conversions includes a double circumference, long cutoff (22 inch-22¾ inch) press base. This attempt includes “three-around” folders, which are operated in either straight mode or triple collects which fold three products per press revolution. In the case of a 22¾ inch double-around press, this produces three 15.167 inch cutoff products per press revolution. Drawbacks to this solution include plate cylinder replacements that are required on double width presses in order to retrofit this conversion attempt. In addition, equipment such as plate cylinder filler-bars are required on 2×2 presses for this attempted solution and prepress conversion to large, three-around plates is required. Another drawback of this large equipment solution is the running of the equipment as a triple collect, which lacks flexibility and produces a three section product with three equally sized sections. In triple collect, a folder with a single former board creates a three section product (e.g., Sections A, B, and C), all three of these sections would have the same number of pages. In triple collect a folder with two former boards creates a six section product (e.g., Sections A, B, C, D, E, and F), sections A, C, and E would have the same number of pages, while sections B, D, and F would also have the same number of pages. When running triple collect it is not possible to produce a 1, 2, 4, or 5 section product. While the shorter cutoffs permit a reduced paper consumption on two-around presses, no solution for providing shorter cutoffs and/or reduced paper usage currently exists for one-around market.

One of the drawbacks to the two-around press arrangements is that there is a requirement of balanced section when running collect, which reduces the flexibility in printing and lacks the ability to size sections differently for optimal ad sales/placement.

Another drawback is that production of a single-around small cutoff press (e.g., less than about 20 inches) requires extensive capital outlay and additional press modification that is not within the framework of existing, known technology.

A method and apparatus that addresses the above-referenced issues and drawbacks would be welcome in the art. The sectioned, folded tabloid paper product and apparatus for making a sectioned, folded tabloid paper product disclosed herein addresses the above-referenced issues without the drawbacks seen in many current folded paper products.

### SUMMARY OF THE INVENTION

One embodiment of the present disclosure includes a sectioned, folded tabloid paper product having a plurality of sections, the sections each having an independent number of pages. The paper product includes a mechanically formed first fold perpendicular to web travel, and a mechanically formed second fold parallel to web travel. The paper product includes a tabloid format that is formed on press.

Another embodiment of the present disclosure includes an apparatus for forming a sectioned, folded tabloid paper product. The apparatus includes a plurality of folding devices arranged and disposed to fold the web perpendicular to web travel to form a tabloid section, a merger arranged and disposed to collect the tabloid sections, and a second folding device arranged and disposed to fold the collected tabloid sections to form a sectioned, folded tabloid paper product.

Embodiments of the present disclosure provide a device to work with existing web fed rotary newspaper presses with little or no mechanical modification to the printing units.

Embodiments of the present disclosure provide a device that creates a conventional looking sectioned broadsheet newspaper product in a reduced size (height×width) without modifying the cutoff of the existing press. In certain embodiments, the system of the present disclosure is retrofitted to existing press lines.

Certain advantages of the system of the present disclosure may be provided by replacing or adding-on to two-around equipment with less-expensive one-around presses. Since running collect is less important when utilizing the system of the present disclosure, publishers running 2×1 or 2×2 presses could add towers or replace capacity with one-around presses, reducing capital costs and increasing production speeds by running straight. The system of the present disclosure may be utilized with double width (4×2) publishers as well.

Embodiments of the present disclosure provide a device for creating a folded paper product that has its height defined by the width of the web (height equals 1 web width, ½ web width, ⅓ web width, ¼ web width, etc.), and its width defined by the cutoff of the press (folded width equals ½ cutoff length). This is typically known as a tabloid or tab product.

Embodiments of the present disclosure provide a device for creating a folded paper product that has its first fold created perpendicular to web travel, and its second fold parallel to web travel.

Embodiments of the present disclosure provide a device for creating a folded paper product with any number of sections (1, 2, 3, 4, 5 etc. sections) arranged in the configuration of a broadsheet newspaper.

Embodiments of the present disclosure provide a device that has the ability of creating these folded sections with varying page counts. Each section can have page jumps in multiples of four, (4 pages, 8 pages, 12 pages, 16 pages, etc.) and no two sections are required to have equal page counts.

Advantages of the present disclosure include the ability to utilize the arrangement of the folding and cutting systems of the present disclosure in conventional 4×2, 2×2, and 2×1 printing presses or other known press arrangements. In addition, in certain embodiments, plate size conversion is not required on existing presses, such as 2×2 or 2×1 presses. In addition, the modified press arrangement of the present disclosure is not constrained to an 18.5 inches or 15.167 inches cutoff; but rather, can be operated at other cutoff sizes, such as from 10 inches to 20 inches or 15 inches to 18 inches cutoff products, or other cutoff products resulting from web width capabilities or existing or future press designs.

Utilizing the cutting and folding system of the present disclosure permits current 2×2 printing press users to immediately offer unbalanced sections with their existing press equipment. In addition, 2×2 printing press users who typically operate the press arrangement collect can run the press arrangement straight, thus increasing press speeds from existing platforms.

Another advantage is that the capacity of existing single-around presses is doubled when utilizing the cutting and folding system of the present disclosure. That is, each web now represents two webs in the smaller format. The cutting and folding system of the present disclosure provides greater utilization of existing equipment and color capacity.

The cutting and folding system according to the present disclosure permits a fold with a lap that yields an ‘above the fold’ front page, allowing insertion of ad inserts without having the inserts extend out of the product. Likewise, the system according to the present disclosure is capable of placing ‘Pop-Up’ ad insert features in all sections for highlighting ads or sales. Further still, since embodiments of the present disclosure can utilize an angle bar section, interleaving of color ribbons can be offered, giving publishers great flexibility in color placement.

An additional advantage of the cutting and folding system of the present disclosure is that there is a reduced or eliminated need for former boards.

### BRIEF DESCRIPTION OF THE DRAWINGS

FIGS. 1 and 2 shows a conventional broadsheet product and a press assembly in straight run mode.

FIGS. 3 and 4 shows a conventional broadsheet product and a press assembly in collect run mode.

FIGS. 5-8 illustrate various steps in the process according to various embodiments of the present device.

FIGS. 9-12 illustrate various steps in a process for forming a tabloid product.

FIGS. 13-14 illustrate exemplary apparatuses according to embodiments of the present disclosure.

FIGS. 15-17 illustrate exemplary mergers according to embodiments of the present disclosure.

FIGS. 18-23 illustrate exemplary apparatuses according to other embodiments of the present disclosure.

FIG. 24 shows an enlarged view of a rotary folder according an embodiment of the present disclosure.

FIG. 25 schematically illustrates a process flow for production of a sectioned tabloid product.

FIG. 26 shows a plan view of a known 2×1 press arrangement.

FIG. 27 shows a elevational view of the press arrangement of FIG. 26.

FIG. 28 illustrates printing by a printing unit to form a broadsheet product with a known 2×1 press arrangement.

FIG. 29 shows a plan view of a 2×1 press arrangement according to an embodiment of the present disclosure.

FIG. 30 shows an elevational view of the press arrangement of FIG. 29.

FIG. 31 illustrates printing by a printing unit to form a tabloid product according to an embodiment of the present disclosure.

FIG. 32 shows a plan view of a known 2×2 press arrangement.

FIG. 33 shows an elevational view of the press arrangement of FIG. 32.

FIG. 34 illustrates printing by a printing unit to form a broadsheet product with a known 2×2 press arrangement.

FIG. 35 shows a plan view of a press arrangement according to another embodiment of the present disclosure.

FIG. 36 shows an elevational view of the press arrangement of FIG. 35.

FIG. 37 illustrates printing by a printing unit to form a tabloid product according to an embodiment of the present disclosure.

### DETAILED DESCRIPTION

Currently to produce a sectioned tabloid product each section must be run separately on the press, then inserted together on a separate device. This takes a lot of time and equipment. The design of the presently disclosed folder produces multiple tabloid folded sections at once, combines them together, and delivers them as a finished product all with one device; this saves both time and money. Money is saved through less machinery, less floor space and less manpower. There are multiple ways to configure this folding machine to produce this product. What follows are exemplary embodiments.

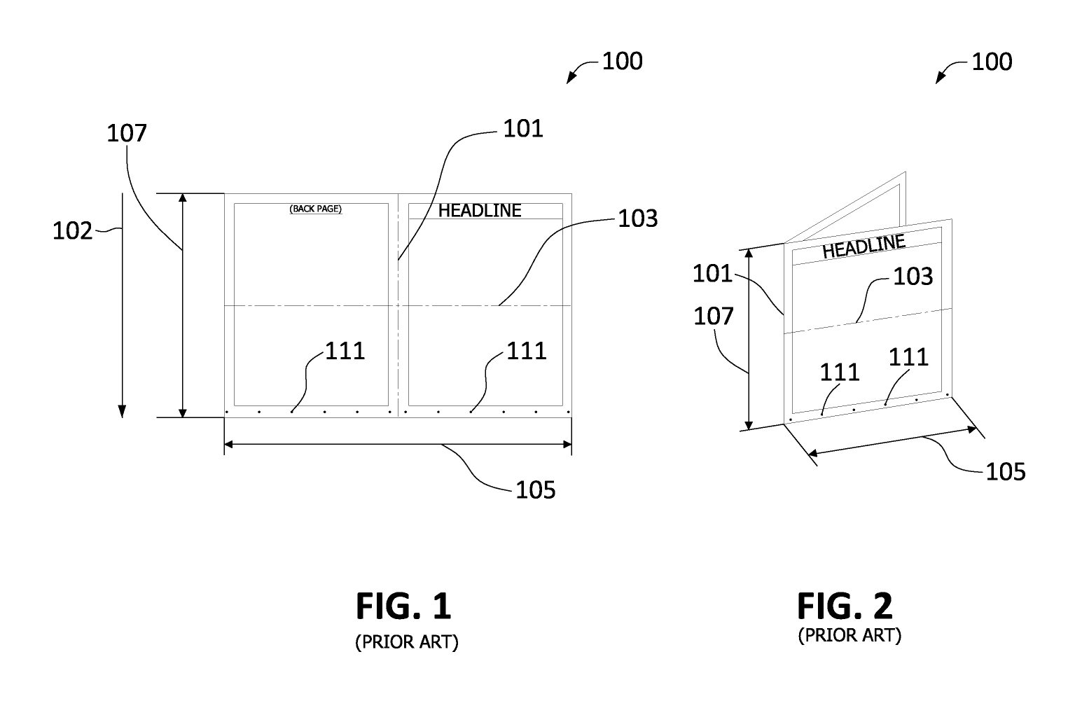

FIGS. 1 and 2 show a known, straight-run broadsheet product 100 that includes a former board fold 101 that is oriented parallel to the direction of web travel 102. The broadsheet product also includes a half-fold 103 that is oriented perpendicular to the direction of web travel 102. The dimensions of the broadsheet product 100 include a web width 105 that is equal to the width of the web fed to the folding apparatus and a cutoff length 107 that corresponds to the circumference of printing cylinders utilized to print on the paper prior to being provided for folding. Common cutoff lengths 107 for known broadsheet products include 21 inches, 21½ inches, 22 inches and 22¾ inches. Pin holes 111 are present along a bottom edge of the broadsheet product 100 and are a result of puncturing pins that grab and direct the paper during the folding process.

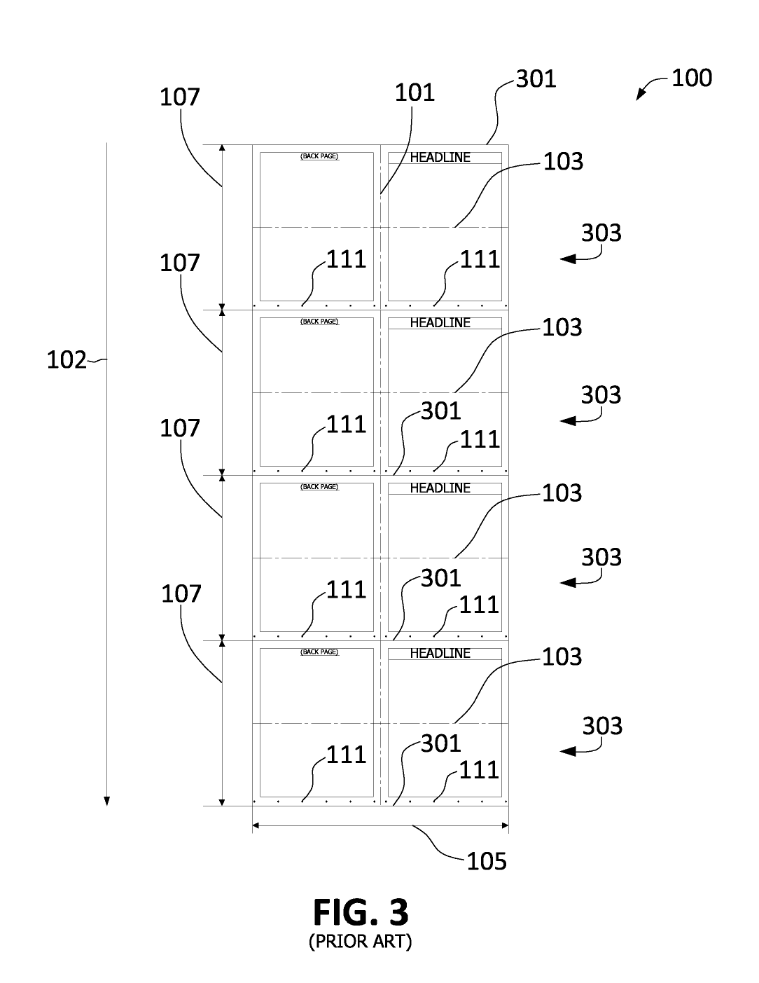

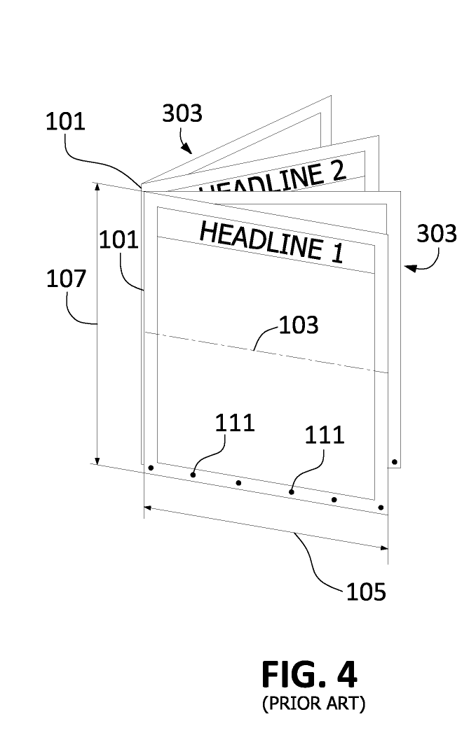

FIGS. 3 and 4 show a known, collect run broadsheet product 100 that includes a former board fold 101 that is oriented parallel to the direction of web travel 102. Similar to the broadsheet product shown in FIGS. 1 and 2, the broadsheet product also includes a half-fold 103 that is oriented perpendicular to the direction of web travel 102. The dimensions of the broadsheet product 100 include a web width 105 that is equal to the width of the web fed to the folding apparatus and a cutoff length 107 that corresponds to the circumference of printing cylinders utilized to print on the paper prior to being provided for folding. Common cutoff lengths 107 for known broadsheet products include 21 inches, 21½ inches, 22 inches and 22¾ inches. Pin holes 111 are present along a bottom edge of the broadsheet product 100 and are a result of puncturing pins that grab and direct the paper during the folding process. Unlike the broadsheet product 100 of FIGS. 1 and 2, the broadsheet product 100 of FIGS. 3 and 4 include broadsheet sections 303 that correspond to adjacent cutoff lengths 107 along the web. As shown in FIG. 4, the broadsheet sections 303 are provided with former board fold 101 and then placed together, wherein the broadsheet sections 303 are provided with a half-fold 103 to place the broadsheet sections 303 adjacent one another.

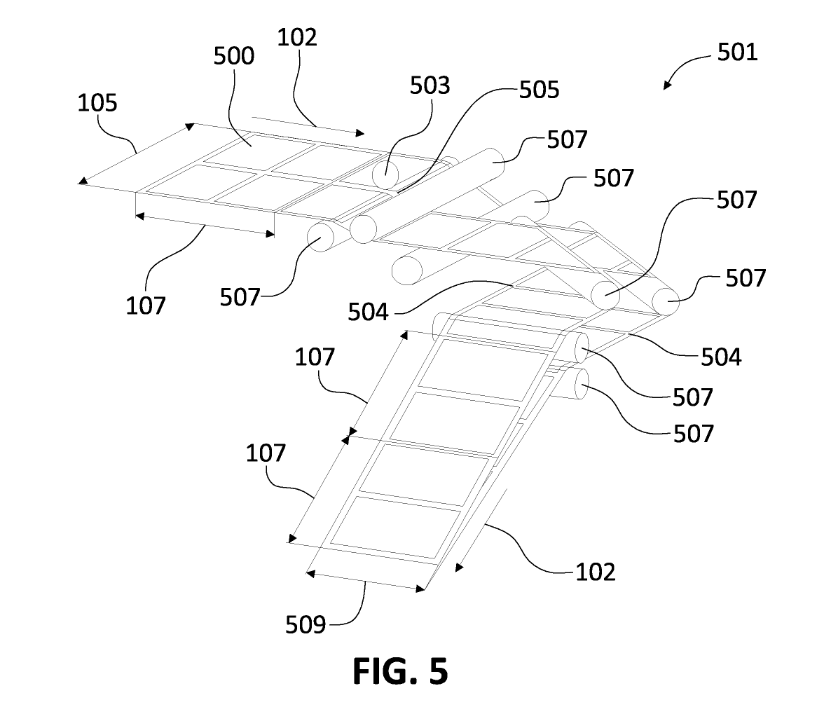

FIG. 5 illustrates a portion of a guide apparatus 501 according to an embodiment of the disclosure. As shown, a paper web 500 is provided from a suitable source, such as a printing press or printing tower. The web 500 travels in direction 102 to a slitter 503, which provides a tabloid split 505 that divides the web 500 into two ribbons 504. Slitter 503 can be a knife or scissor-like structure capable of cutting the paper web into ribbons 504. Suitable slitters 503 may include, for example, an anvil slitter or a shear slitter, both of which include structures generally known in the art for cutting paper. The ribbons 504 are individually guided by guide bars 507 to be provided to a folding apparatus. To produce additional pages and/or sections a plurality of webs 500 may be provided to a plurality of guide apparatuses 501, which may then be provided to a folding apparatus.

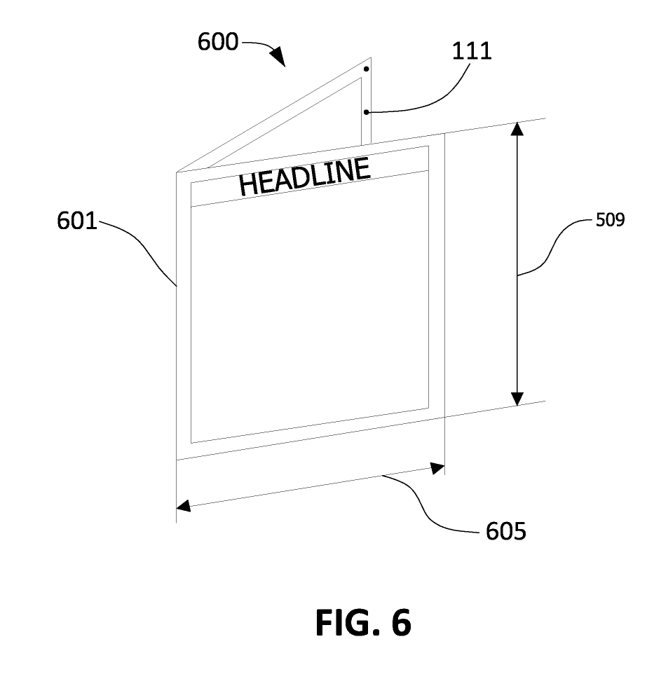

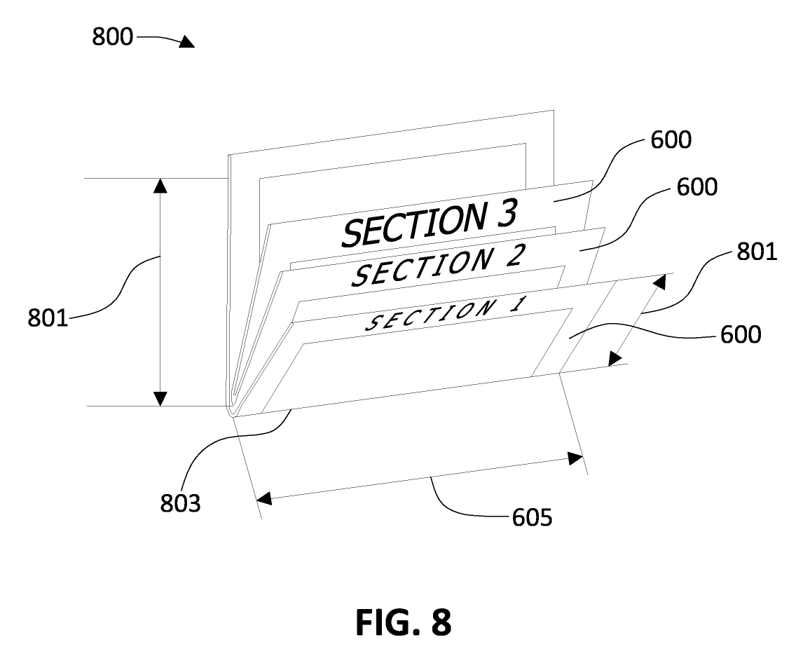

FIG. 6 shows a tabloid section 600 according to an embodiment of the disclosure prior to assembly into a finished sectioned tabloid 800 (see FIG. 8). Each of the ribbons 504 from FIG. 5 are folded and cut to form a tabloid section 600. The tabloid section 600 includes a first fold 601 and has dimensions, including a horizontal dimension, forming the page width 605, which corresponds to ½ the cutoff length 107 (see FIG. 5), and a vertical dimension forming the page height or ribbon width 509. Also visible in FIG. 6 are pin holes 111 that align the vertical dimension forming the page height of the back page, which corresponds to where the paper is grabbed by pins in the folding apparatus. The pin holes 111 are aligned perpendicular to direction of web travel 102. Although tabloid section 600 is shown as a single sheet of paper in FIG. 6, additional sheets may be provided. Additional sheets of paper to form tabloid section 600 and are folded in the same manner as shown in FIG. 6 and are nested together (see e.g., FIGS. 10 and 12). While the above tabloid section 600 is shown and described as including pin holes 111, tabloid section 600 may be devoid of pin holes, particularly when the folding is accomplished with pinless folders.

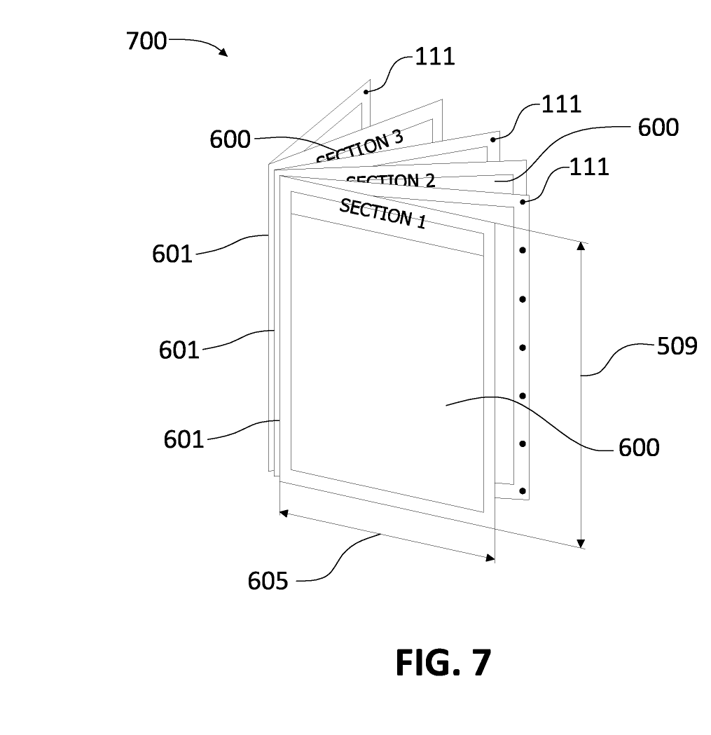

FIG. 7 shows an intermediate tabloid product 700 in the formation of the sectioned tabloid (see FIG. 8), wherein the tabloid sections 600, such as the section shown in FIG. 6, are assembled together with the first fold 601 aligned together. The assembled intermediate tabloid product 700 may provide tabloid sections having vertical and horizontal dimensions that are aligned together. Alternatively, in other embodiments, the a lap may be provided in the intermediate tabloid product 700 wherein the first fold 601 is aligned together, but the pages therein and/or the sections 600 therein may be offset vertically to provide a lap. The intermediate tabloid product 700 includes multiple sections 600, wherein the individual sections 600 are arranged adjacent one another and are not nested.

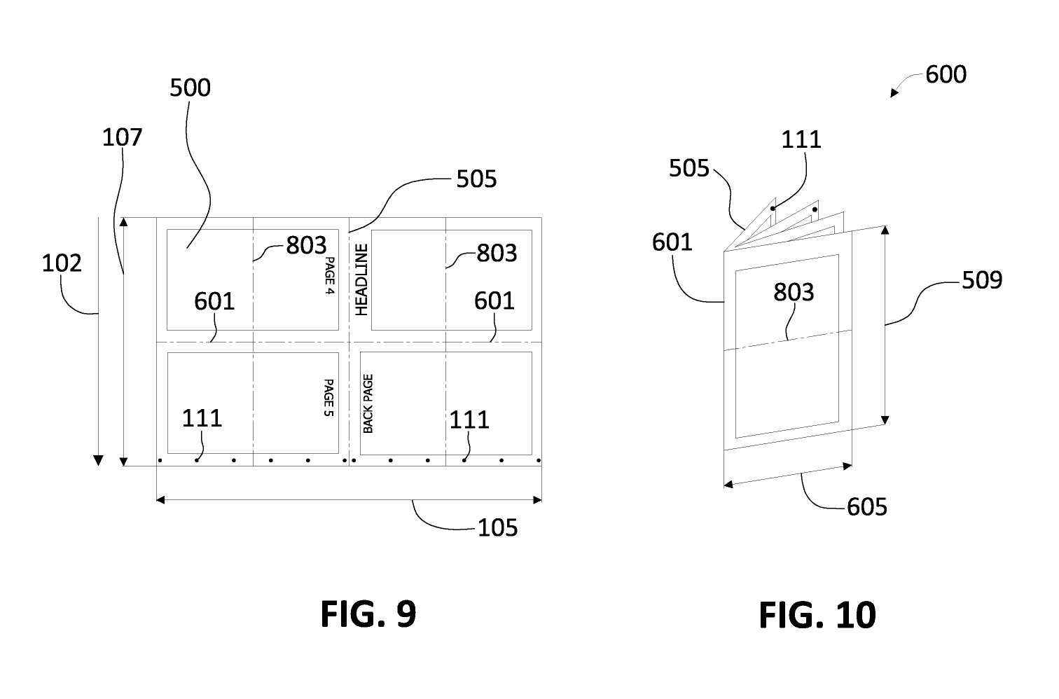

FIG. 8 shows a finished sectioned tabloid 800 according to embodiment of the disclosure. The sectioned tabloid 800 is a folded paper product that includes a plurality of tabloid sections 600. The tabloid sections each include an independent number of pages. The sectioned tabloid 800 includes a mechanically formed first fold 601 perpendicular to the direction of web travel 102 (see FIGS. 9-12). In addition the sectioned tabloid 800 includes a mechanically formed second fold 803 parallel to the direction of web travel 102 (see for example FIGS. 9-12). The second fold 803 forms a quarter fold length that represents a vertical dimension allowing viewing of, for example, half of the first page of the sectioned tabloid 800. The sectioned tabloid 800 is a paper product in tabloid format and is formed on press. “On press”, as utilized herein, means that the folded paper product is formed in a continuous process from a web fed from a printing apparatus to the completed, folded sectioned tabloid 800. Production “on press” further includes the continuous process without manual folding or manual assembly, without manual or semi-automated joining of separate tabloid sections 600, and/or without manual or semi-automated joining of tabloid sections 600 or pages printed at different times or dates.

FIG. 9 shows an enlarged view of an exemplary configuration of one cutoff length 107 of web 500 for use in the formation of tabloid section 600. The embodiment shown in FIG. 9 represents a configuration of web 500 that would be straight-run through a folding apparatus. In this embodiment, the single cutoff length 107 of web 500 forms 8 pages to form a tabloid section 600, as shown in FIG. 10. As shown in FIGS. 9 and 10, the web 500 is split at tabloid split 505 to form separate ribbons (see FIG. 5). In addition, FIGS. 9 and 10 show a broken line representing first fold 601 as oriented perpendicular to the direction of web travel 102. Further, a broken line representing second fold 803 is shown oriented parallel to the direction of web travel 102. Also visible in FIGS. 9 and 10 are dots representing the placement of pin holes 111 that align the vertical dimension forming the page height of the back page, which corresponds to where the paper is grabbed by pins in the folding apparatus. The pin holes 111 are aligned perpendicular to direction of web travel 102.

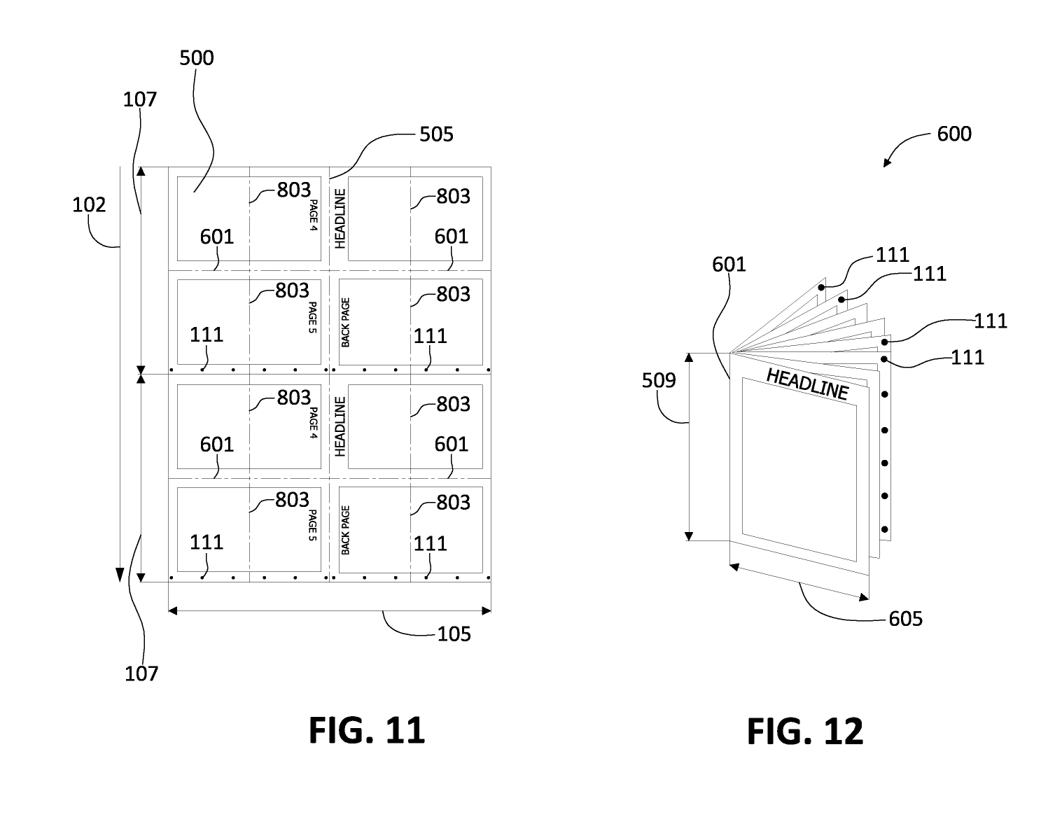

FIG. 11 shows an enlarged view of an exemplary configuration of two cutoff lengths 107 of web 500 for use in the formation of tabloid section 600. The embodiment shown in FIG. 11 represents a configuration of web 500 that may be run collect through the folding apparatus. In this embodiment, each cutoff length 107 of web 500 forms 8 pages for 16 pages total to form a tabloid section 600, as shown in FIG. 12. As shown in FIGS. 11 and 12, the web 500 is split into a tabloid split 505 to form separate ribbons 504 (see FIG. 5). In addition, FIGS. 11 and 12 show a line representing first fold 601 as oriented perpendicular to the direction of web travel 102. In addition, a line representing second fold 803 is shown oriented parallel to the direction of web travel 102. Also visible in FIGS. 11 and 12 are pin holes 111 that align the vertical dimension forming the page height of the back page, which corresponds to where the paper is grabbed by pins in the folding apparatus. The pin holes 111 are aligned perpendicular to direction of web travel 102.

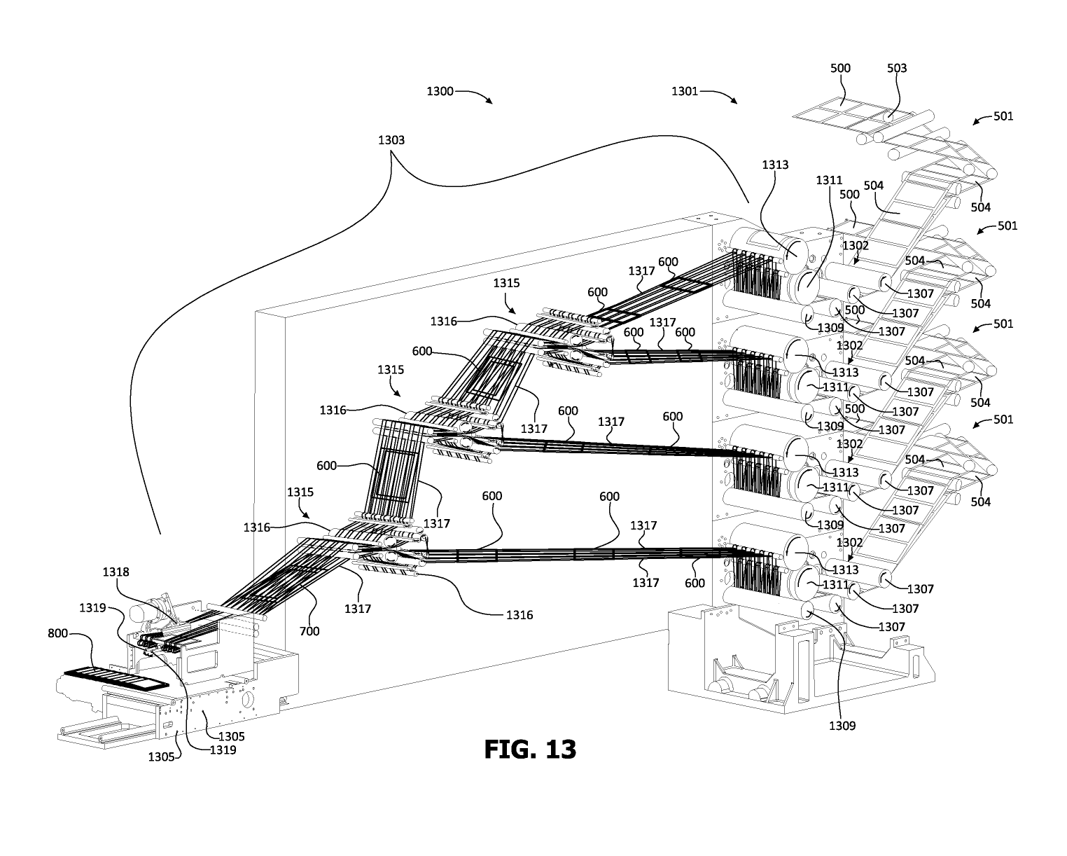

FIG. 13 shows a folding apparatus 1300 according to an embodiment of the disclosure. As shown in FIG. 13, the folding apparatus 1300 includes four guide apparatuses 501 (see also FIG. 5), a perpendicular half-page fold section 1301, a merge section 1303 and a quarter-page fold apparatus 1305. The guide apparatuses 501 include the structures shown and described above with respect to FIG. 5. The individual guide apparatuses 501 provide ribbons 504 to the perpendicular half-page fold section 1301. The perpendicular half-page fold section 1301 is made up a series of first folding devices 1302. The first folding devices 1302 are made up of a series of tension rollers 1307 that provide tension and feed the ribbons 504 to a cutting cylinder 1309 that cuts the ribbon at cutoff length 107. The cut ribbon 504 is then fed to a pin-tucker cylinder 1311 that grabs the paper with pins, forming pin holes 111 and tucks the paper against jaw cylinder 1313, which grabs the cut paper with a pair of jaws or other suitable structure forms first fold 601, and produces tabloid section 600. The tabloid section 600 is pulled around the jaw cylinder 1313 and fed to the merge section 1303. The merge section 1303 is made up a series of three mergers 1315. The mergers 1315 are devices that include tape 1317 or other suitable structure which are driven and guided by rollers 1316 to transport and join the tabloid sections 600 together to form intermediate tabloid product 700. In this embodiment, the mergers 1315 are arranged with a cascading or substantially diagonal configuration. The arrangement shown in this embodiment permits flexibility in operation. For example, the individual first folding devices 1302 may be selectively deactivated, while permitting the other first folding devices 1302 to continue to operate to form the intermediate tabloid products 700. The merge section 1303 feeds the intermediate tabloid product 700 to the quarter-page fold apparatus 1305. The quarter-page fold apparatus 1305 provides intermediate tabloid product 700 with second fold 803 to form sectioned tabloid 800. In the embodiment shown, the quarter-page fold apparatus 1305 includes a chopper 1318 that drives the intermediate tabloid product 700 through crushing rollers 1319, which folds the intermediate tabloid product 700 along second fold 803 and lays the completed sectioned tabloid 800 onto a conveyer as a product suitable for distribution to a customer. The ribbons 504 fed to the first folding device 1302 may be arranged to provide offset or lapped sectioned tabloid products 800. In embodiments wherein a lap or a pop-up add is desired, the ribbons may be offset from one another providing a lap or overlay that is carried through to the finished sectioned tabloid product 800. In addition, the intermediate tabloid product 700 may be folded off-center in the quarter-page fold apparatus 1305 to provide an off-center fold, when desired, to provide a lap or pop-up ad.

Although FIG. 13 shows four first folding devices 1302, any number of first folding devices may be utilized to provide the desired number of pages and desired number of sections. The configuration may include, for example, a first folding device 1302 for each tabloid section 600. The first folding device 1302 creates a fold perpendicular to direction of web travel 102 and cuts the product to cutoff length 107. The first folding device 1302 can include a variety of folding apparatus designs, including, known folding apparatus components, such as a 1:2 rotary folder, 1:2:2 jaw folder, 2:2 jaw folder, 1:3:3 jaw folder, or other folder designs. Each first folding device 1302 and its related tension rollers 1307 are housed in a framework that can either be stacked vertically or horizontally to form a single device, or perpendicular half-page fold section 1301 that produces multiple tabloid sections 600.

Creating the first fold 601 can be accomplished utilizing a variety of equipment configurations. Two exemplary types are Jaw Folders and Rotary Folders. Jaw Folders, for example, create a fold in the paper by having a tucking blade that tucks the product between a stationary jaw and a moveable jaw that closes on the product creating a fold. Jaw Folders can be divided into two groups, 2-cylinder folders and 3-cylinder folders. A 2-cylinder jaw folder consists of a first cylinder that contains a tucking blade, a set of pins, and a cut off knife. This cylinder has a circumference equal to an even cut off length, but can be one-around, two-around, three-around, etc. The second cylinder is the jaw cylinder that contains the folding jaws and the cutoff rubbers. This cylinder can also be one-around, two-around, three-around, etc. A suitable example of a 1:2 jaw folder includes a DGM 1030/1035 Folder available from DGM Manugraph, Elizabethville, Pa. As used herein, 1:2 refers to a one-around (1-cutoff=circumference) tucking/pin/cutting cylinder and a two around jaw/cutting rubbers cylinder. A 3-cylinder jaw folder design is a common design in the industry with many companies making a variety of 3-cylinder jaw folders. 3-cylinder jaw folders are typically equipped with a first cylinder having a cutoff knife, a second cylinder having tucker blades, pins and cutting rubbers, with a third cylinder having jaws. Two examples of 3-cylinder jaw folders include a 1:2:2: DGM 1240 and a 2:3:4 DGM 1270 folder available from DGM Manugraph, Elizabethville, Pa. The 1:2:2 and 2:3:4 refers to the circumference size of the cylinders as in the 2-cylinder jaw folders. An example of a 3-cylinder 1:2:2 jaw folder is shown in FIG. 13. Rotary folders create a fold in the paper by having a rotary spinning tucking blade tuck the product between two rotating rollers that form the fold. Rotary folders are typically equipped with a cutting cylinder and a combination pin/tucking cylinder. An example of a 1:2 rotary folder includes the DGM 1255, available from DGM Manugraph, Elizabethville, Pa. This type of folder includes a one-around cutting cylinder, and a two-around pin-tucking cylinder.

After leaving the first folding device 1302 as cut and folded tabloid sections 600, these sections 600 are merged together by a merger 1303, which may consist of a series of tapes and/or grippers. The tabloid sections 600 are brought together with their first folds 601 aligned. These aligned sections form the intermediate tabloid product 700 and are then directed to quarter-page fold apparatus 1305 that creates a second fold 803 perpendicular to the first fold 601 made by the first folding device 1302. This finished sectioned tabloid 800 is then delivered out of the apparatus.

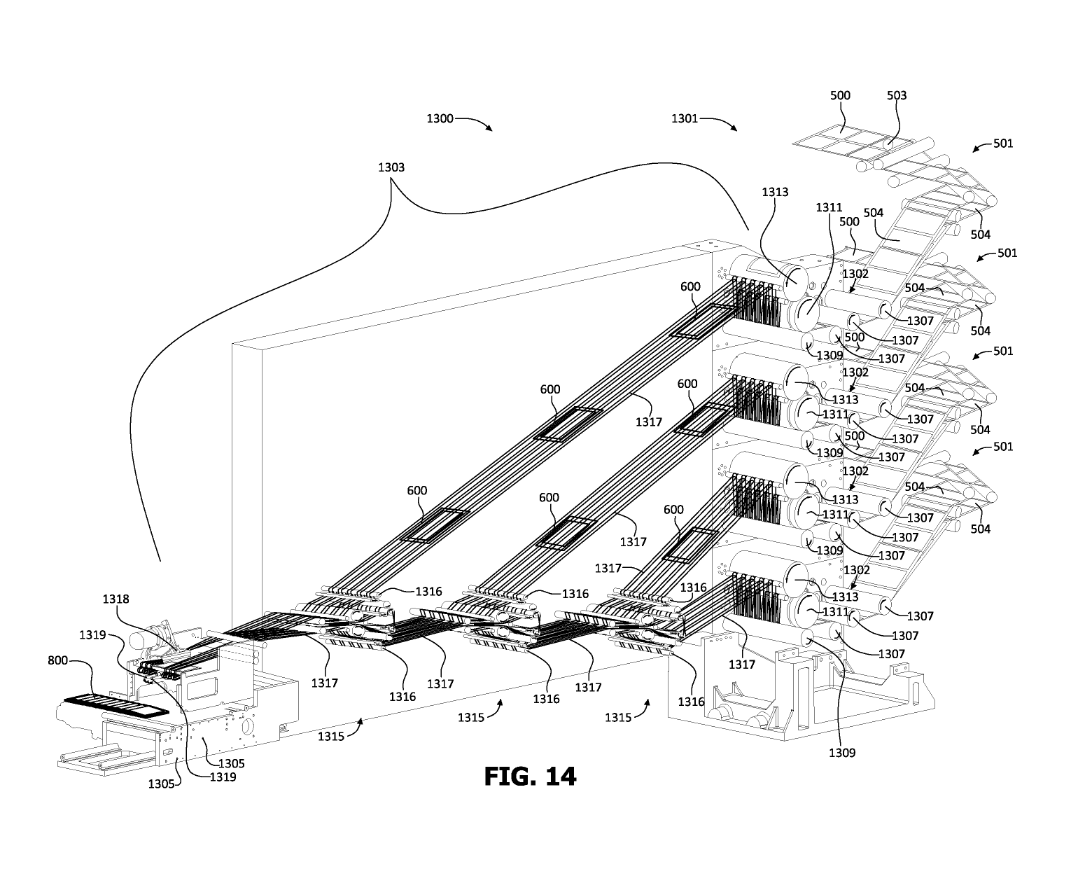

FIG. 14 has a similar arrangement of equipment as the folding apparatus 1300 shown and described with respect to FIG. 13. However, the merge section 1303 includes the mergers 1315 aligned in a substantially horizontal configuration. In the embodiment shown in FIG. 14, the merge section 1303 is located close to the ground, which increases accessibility for servicing or maintenance. In addition, like the arrangement in FIG. 13, the individual first folding devices 1302 may be individually deactivated to provide greater flexibility in operation.

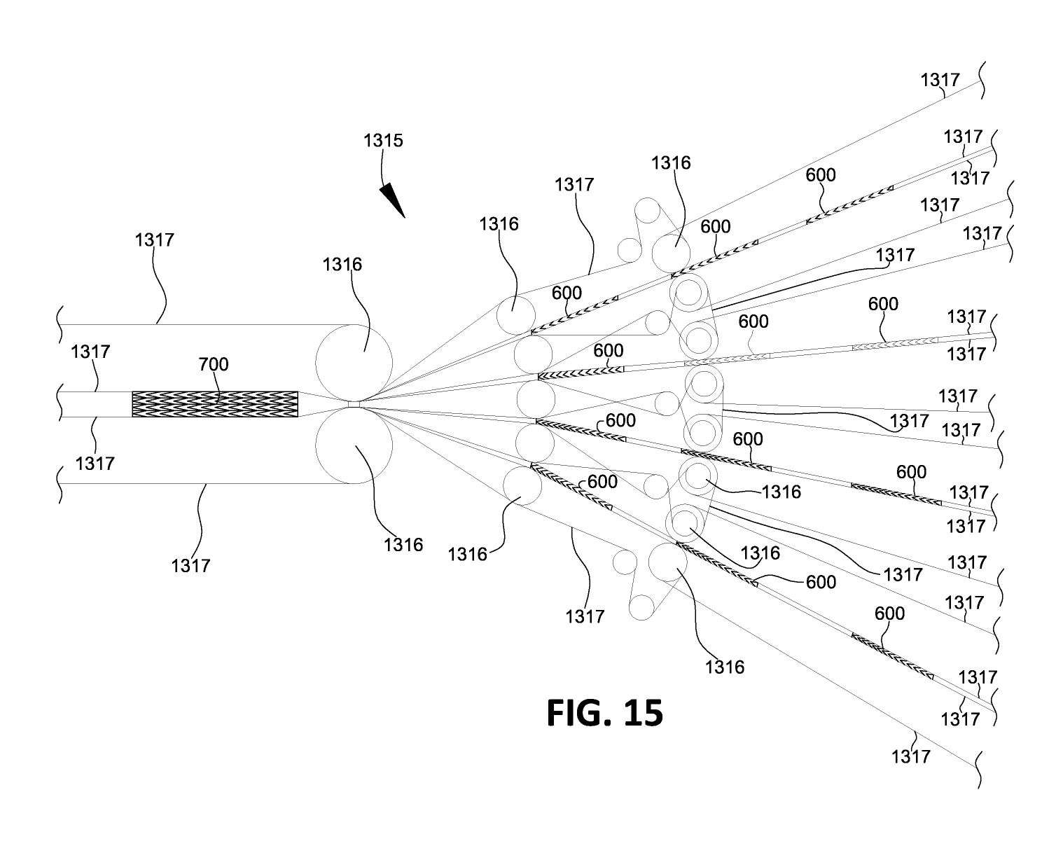

FIGS. 15-17 show alternative mergers 1315 suitable for use in merge section 1303 according to an embodiment of the present disclosure. In each embodiment the tabloid section 600 (see e.g., FIG. 6) is provided to the merger 1315 and is positioned adjacent one or more other tabloid section 600 to form an intermediate tabloid product 700 (see e.g., FIG. 7). In FIG. 15, each of the mergers 1315 includes rollers 1316 around which are positioned tapes 1317 or other suitable structure for gripping, driving, conveying or guiding the paper products. The rollers 1316 may be drive rollers or may be coasting, freely rotating rollers. The tapes 1317 travel around rollers 1316 and are configured in a manner that permits conveyance and/or joining of consolidation of different paper products.

In FIG. 15, the tabloid section 600 is provided by the merger 1315 from four distinct angles. For example, the tabloid sections 600 may be provided from four different areas of the perpendicular half-page fold section 1301 (see e.g., FIG. 13). The tabloid sections 600 may be provided in any suitable manner to merger 1315 and may be provided by tapes 1317 driven by rollers 1316 or any other suitable paper conveyance device. The tabloid sections 600 are conveyed together and are positioned adjacent one another to form intermediate tabloid product 700. In the arrangement shown in FIG. 15, the angle at which the tabloid sections 600 are brought together is relatively low providing for better paper movement and control. In addition, the embodiment shown in FIG. 15 is compact and does not require a lot of floor space.

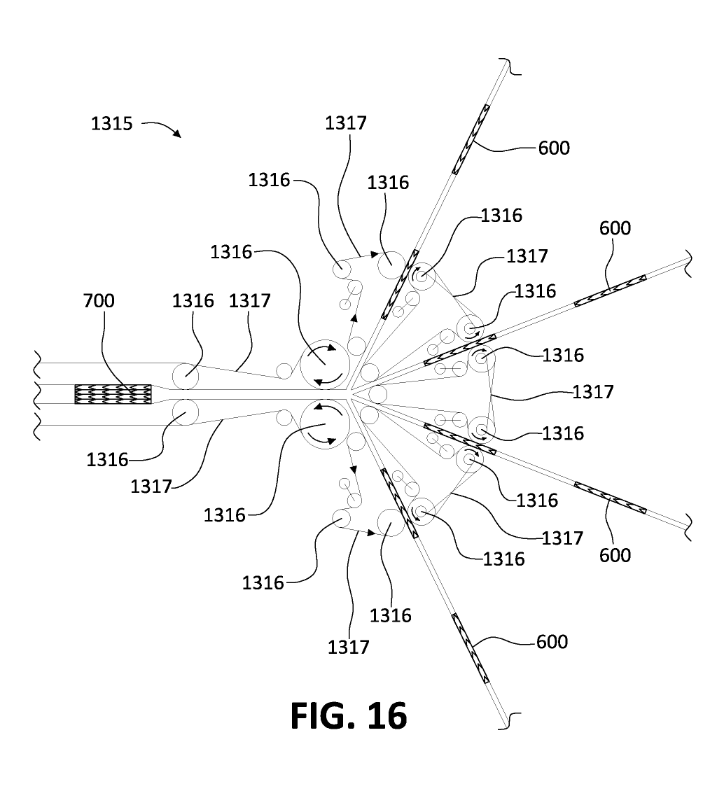

FIG. 16 shows an arrangement similar to FIG. 15, wherein the tapes 1317 convey the tabloid sections 600 into an adjacent arrangement at an angle higher than the angle present in the merger 1315 of FIG. 15. In the embodiment shown in FIG. 16, the arrangement provides a unitary piece of equipment to merge tabloid section 600 without requiring a large amount of floor space.

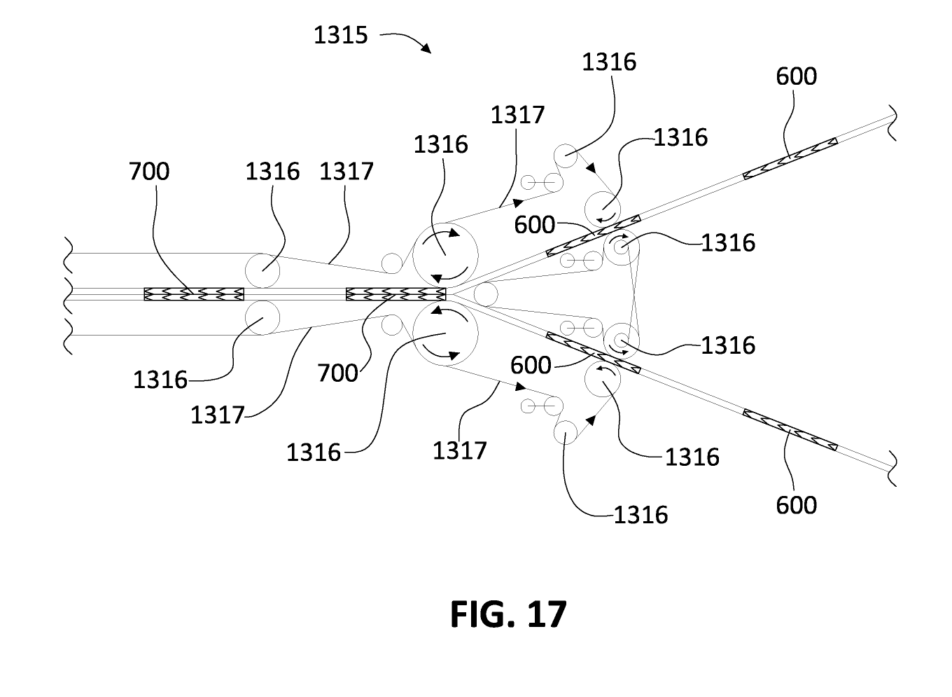

In FIG. 17, the tabloid sections 600 are provided from two distinct angles. For example, the tabloid sections 600 may be provided from two different areas of the perpendicular half-page fold section 1301 (see e.g., FIG. 13). In the arrangement shown in FIG. 17, the angle at which the tabloid sections 600 are brought together is relatively low providing for better paper movement and control. In addition, the equipment forming the merger 1315 is simple and provides good paper travel and control.

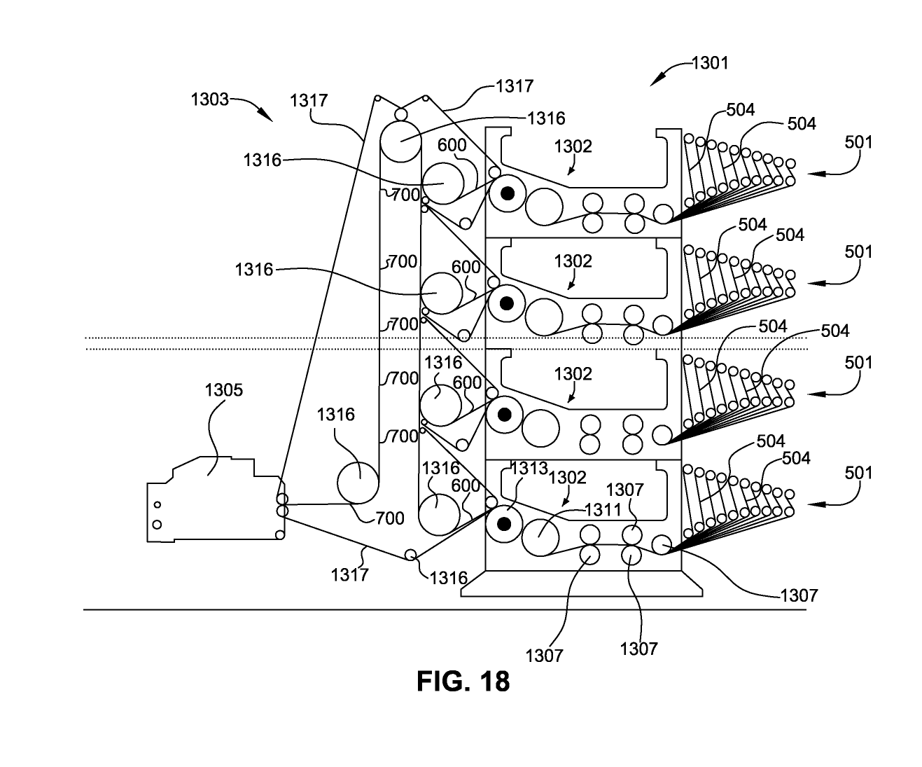

FIG. 18 shows another embodiment of the present disclosure, wherein ribbons 504 are provided to perpendicular half-page fold section 1301. The ribbons 504 are cut and folded with a first fold 601 (see e.g., FIG. 6) and are provided to merge section 1303. In this section, a series of tapes 1317 and rollers 1316 vertically oriented join the tabloid sections 600 together vertically as the tapes 1317 convey the tabloid sections vertically upward parallel to the perpendicular half-page fold section 1301. Once the intermediate tabloid product 700 is formed, the tapes 1317 convey the intermediate tabloid product 700 to the quarter-page fold apparatus 1305. The embodiment shown in FIG. 18 provides a shortened machine that requires less floor space. In addition, the arrangement permits selective deactivation of first folding devices 1302 to provide greater flexibility during operation.

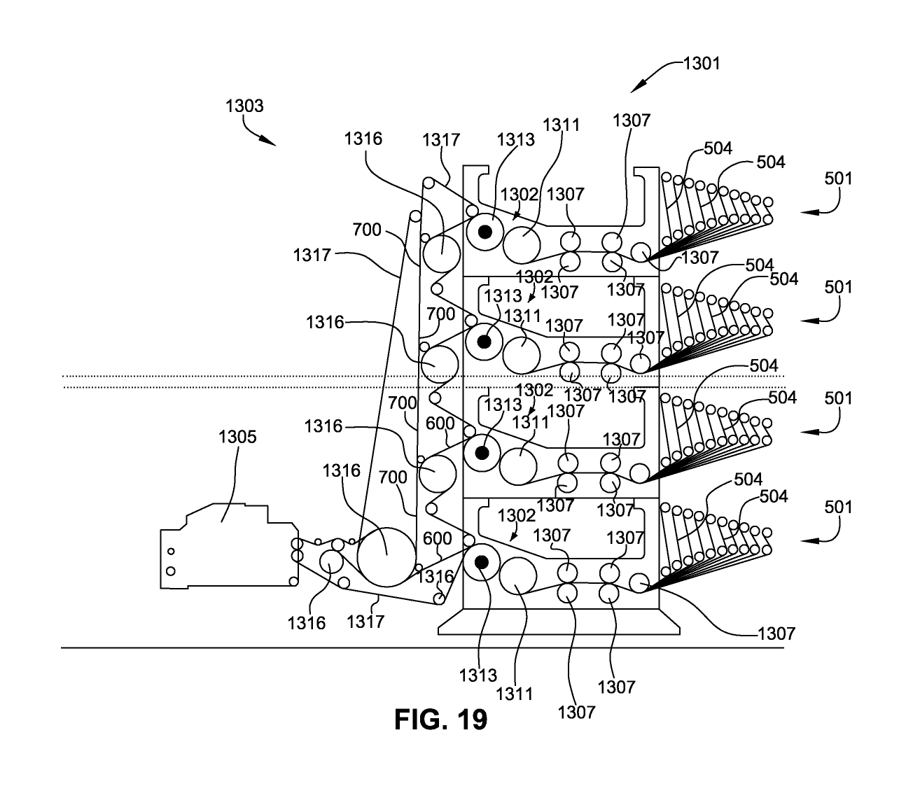

FIG. 19 shows another embodiment of the present disclosure, wherein ribbons 504 are provided to perpendicular half-page fold section 1301. The ribbons 504 are cut and folded with a first fold 601 (see e.g., FIG. 6) and are provided to merge section 1303. In this section, a series of tapes 1317 and rollers 1316 are vertically oriented and join the tabloid sections 600 together vertically as the tapes 1317 convey the tabloid sections vertically downward parallel to the perpendicular half-page fold section 1301. Once the intermediate tabloid product 700 is formed, the tapes 1317 convey the intermediate tabloid product 700 to the quarter-page fold apparatus 1305. The embodiment shown in FIG. 19 provides a shortened machine with a shorter paper flow from the perpendicular half-page fold section 1301 to the quarter-page fold apparatus 1305. In addition, the arrangement permits selective deactivation of first folding devices 1302 to provide greater flexibility during operation.

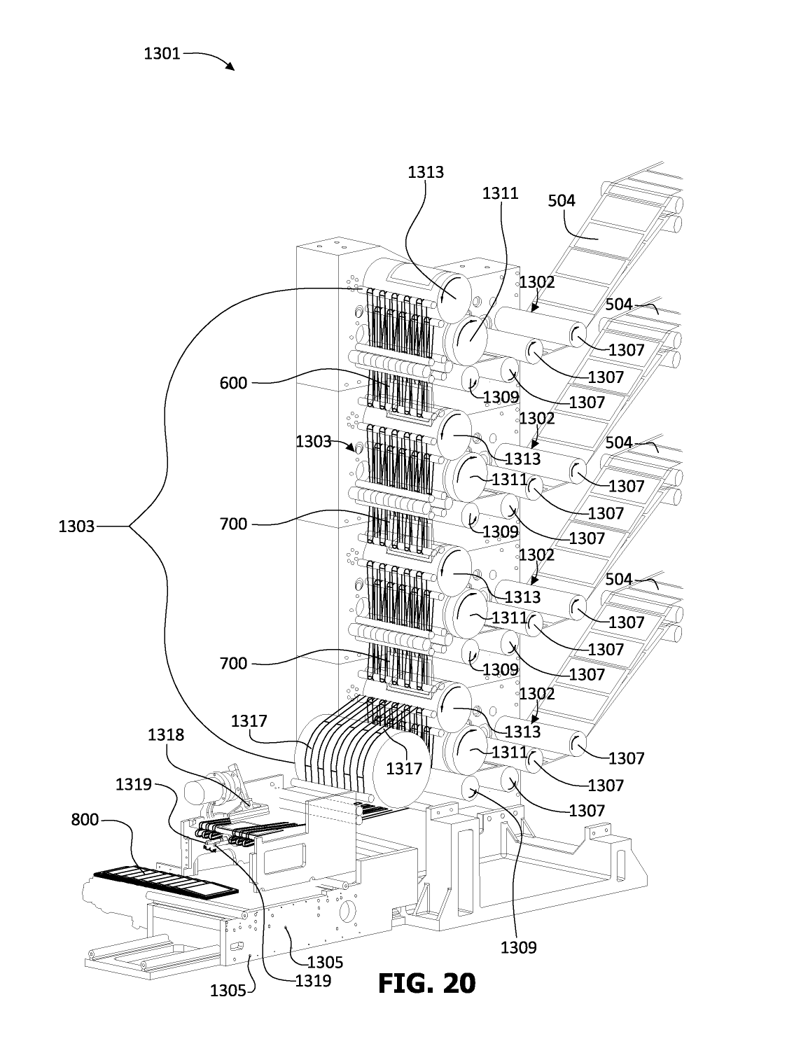

FIG. 20 shows another embodiment of the present disclosure, wherein ribbons 504 are provided to perpendicular half-page fold section 1301. The ribbons 504 are cut and folded with a first fold 601 (see e.g., FIG. 6) and are provided to merge section 1303. In this section, a series of tapes 1317 and rollers 1316 are vertically oriented and join the tabloid sections 600 together vertically as the tapes 1317 convey the tabloid sections vertically downward parallel to the perpendicular half-page fold section 1301. Once the intermediate tabloid product 700 is formed, the tapes 1317 convey the intermediate tabloid product 700 to the quarter-page fold apparatus 1305. The embodiment shown in FIG. 20 provides a merge section that is oriented vertically to provide a shortened machine with a shorter paper flow from the perpendicular half-page fold section 1301 to the quarter-page fold apparatus 1305. In addition, the arrangement of FIG. 20 permits ribbons 504 to be provided from any suitable source. For example, ribbons 504 may be provided by former boards or similar devices configured with slitters 503. In another embodiment, a plurality of webs 500 may be fed to a single former board to produce multiple webs 504 prior to being provided to perpendicular half-page fold section 1301. In other embodiments ribbons 504 may be fed directly from paper rolls.

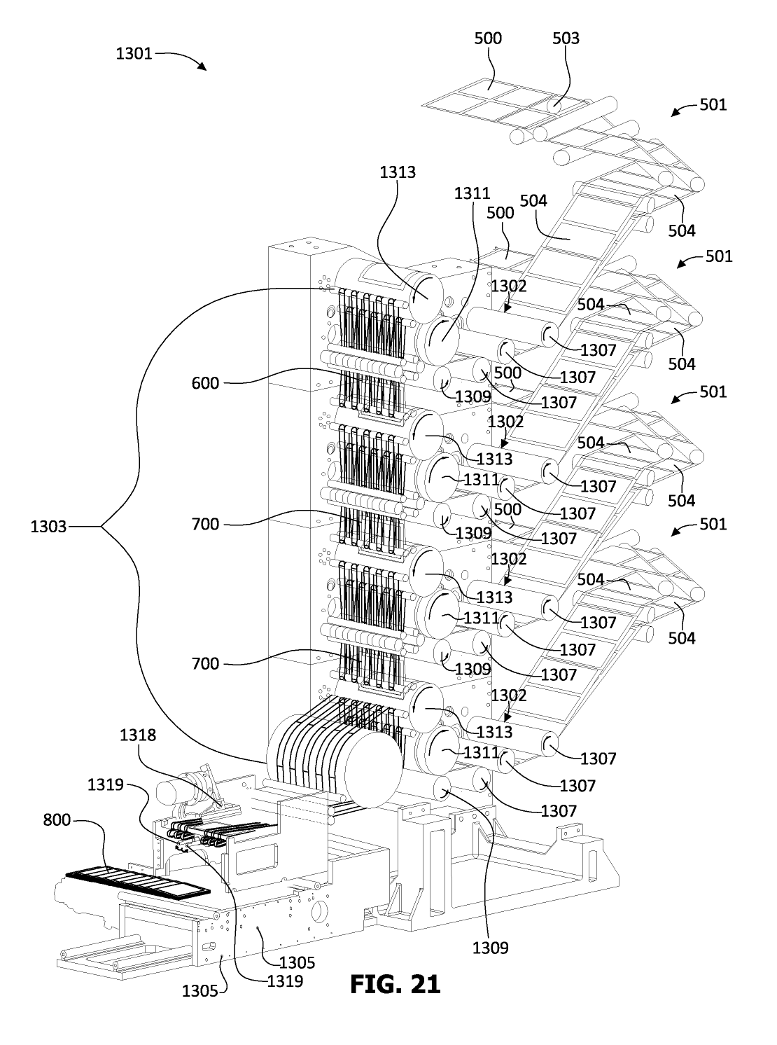

FIG. 21 shows another embodiment of the present disclosure, wherein ribbons 504 are formed by cutting webs 500 with a slitter 503 and guiding the ribbons 504 to the perpendicular half-page fold section 1301. The ribbons 504 are cut and folded with a first fold 601 (see e.g., FIG. 6) and are provided to merge section 1303. In this section, a series of tapes 1317 and rollers 1316 join the tabloid sections 600 together vertically as the tapes 1317 convey the tabloid sections vertically downward parallel to the perpendicular half-page fold section 1301. Once the intermediate tabloid product 700 is formed, the tapes 1317 convey the intermediate tabloid product 700 to the quarter-page fold apparatus 1305. The embodiment shown in FIG. 21 provides a merge section that is oriented vertically to provide a shortened machine with a shorter paper flow from the perpendicular half-page fold section 1301 to the quarter-page fold apparatus 1305.

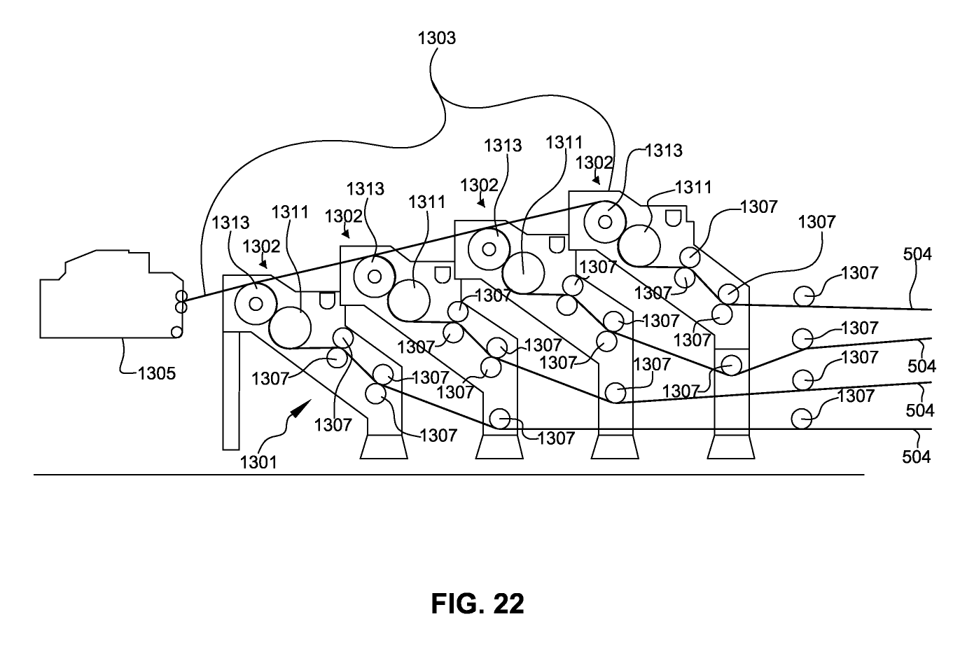

FIG. 22 shows another embodiment of the present disclosure, wherein ribbons 504 are provided to perpendicular half-page fold section 1301. The ribbons 504 are cut and folded with a first fold 601 (see e.g., FIG. 6) and are provided to merge section 1303. In this section, a series of tapes 1317 and rollers 1316 (not shown) join the tabloid sections 600 together vertically as the tapes 1317 convey the tabloid sections in a diagonal direction parallel to the perpendicular half-page fold section 1301. Once the intermediate tabloid product 700 is formed, the intermediate tabloid product 700 is conveyed to the quarter-page fold apparatus 1305. The embodiment shown in FIG. 22 provides a merge section that is oriented horizontally to provide a machine having reduced head space.

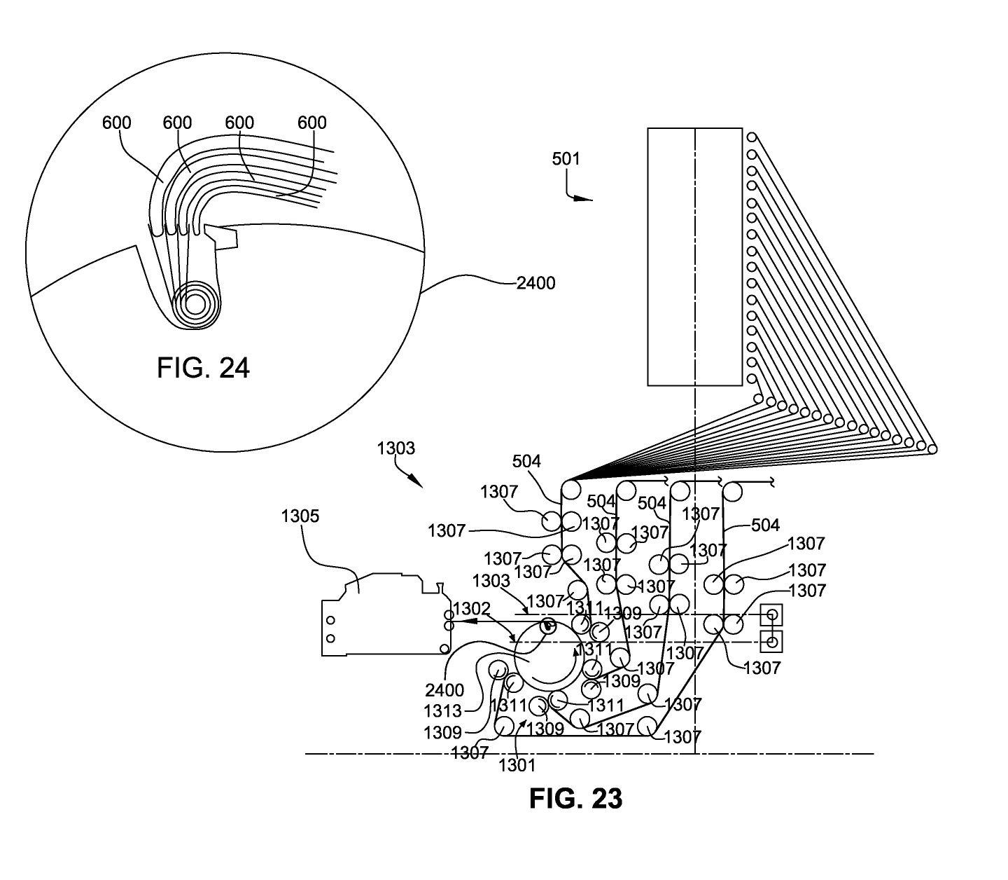

Another way to produce a sectioned tabloid 800 on a unitary machine is to have a rotary folder that has a common jaw cylinder that has a series of pin/tucker cylinders surrounding it. FIG. 23 shows another embodiment of the present disclosure, wherein ribbons 504 are provided to a section of the device that has a consolidated perpendicular half-page fold section 1301 and merger 1303. The ribbons 504 are cut and folded with a first fold 601 (see e.g., FIG. 6) and are simultaneously merged with the rotary folder arrangement. This simultaneous fold and merge is accomplished by a rotary folder that has a common jaw cylinder that has a series of pin/tucker cylinders surrounding it. FIG. 24 shows an enlarged portion 2400 of the rotary jaw folder arrangement shown in FIG. 23. A plurality of jaws 2401 grip a tabloid section 600 in a tucking cylinder 2405 from each of the first folding devices 1302 against a block 2403 until all of the tucking cylinders 2405 have received tabloid sections 600. Each tucking cylinder 2405 in a rotary folder progressively tucks a tabloid section 600 into the jaws 2401 merging tabloid sections 600. The merged tabloid sections 600 are delivered as intermediate product 700 to the quarter-page fold apparatus 1305.

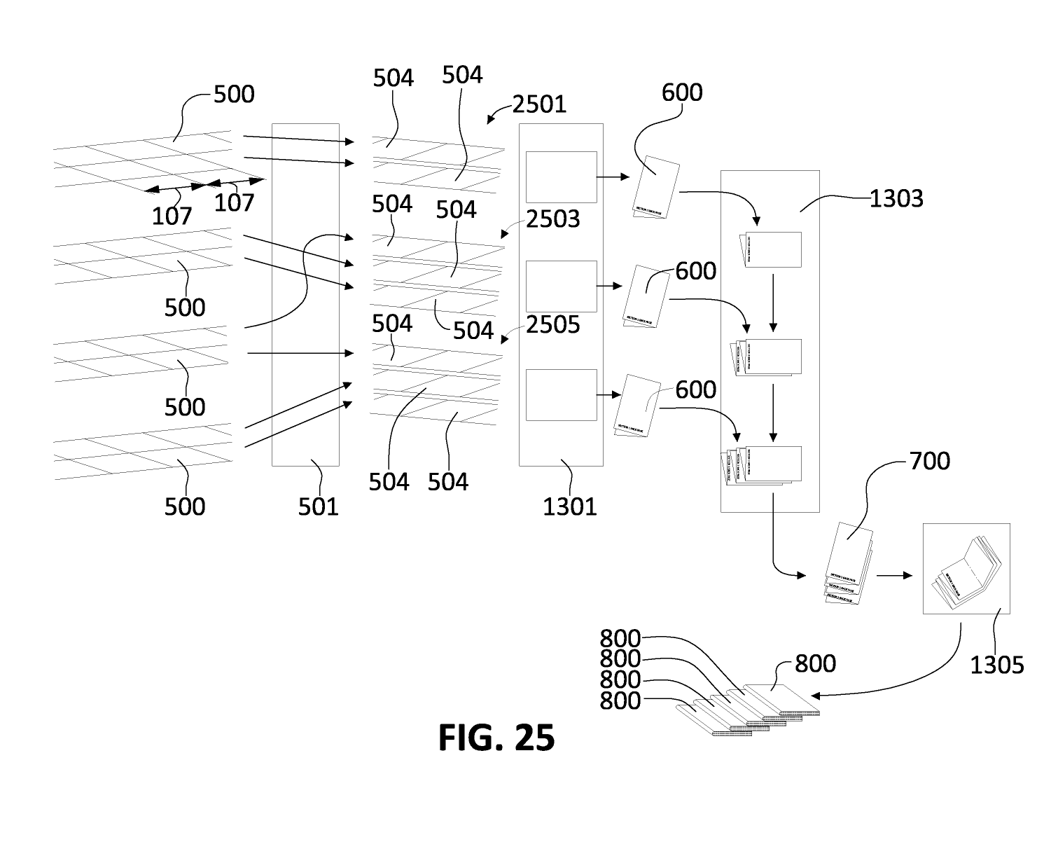

FIG. 25 shows a process flow shown schematically for a process for forming a sectioned tabloid 800. As shown in FIG. 25, a web 500 is provided to a guide apparatus 501 and the webs are split into ribbons 504. As shown in FIG. 25, the ribbons are directed to the particular first folding devices 1302 desired, wherein the ribbons may be provided from different webs 500. That is, as shown, a first set of ribbons 2501 includes two ribbons from a single web. A second set of ribbons 2503 includes three ribbons from two different webs 500. A third set of ribbons 2505 includes three ribbons from two different webs 500. Each of the first set of ribbons 2501, second set of ribbons 2503, and third set of ribbons 2505 form a tabloid section 600 of sectioned tabloid 800. The ribbons 504 are then provided to perpendicular half-page fold section 1301, wherein the tabloid section 600 is formed. The tabloid sections are then provided to the merge section 1303, wherein the tabloid sections 600 are joined to form intermediate tabloid product 700. The intermediate tabloid product 700 is then provided to the quarter-page fold apparatus, wherein the intermediate tabloid product 700 is folded to form sectioned tabloid 800.

### EXAMPLES

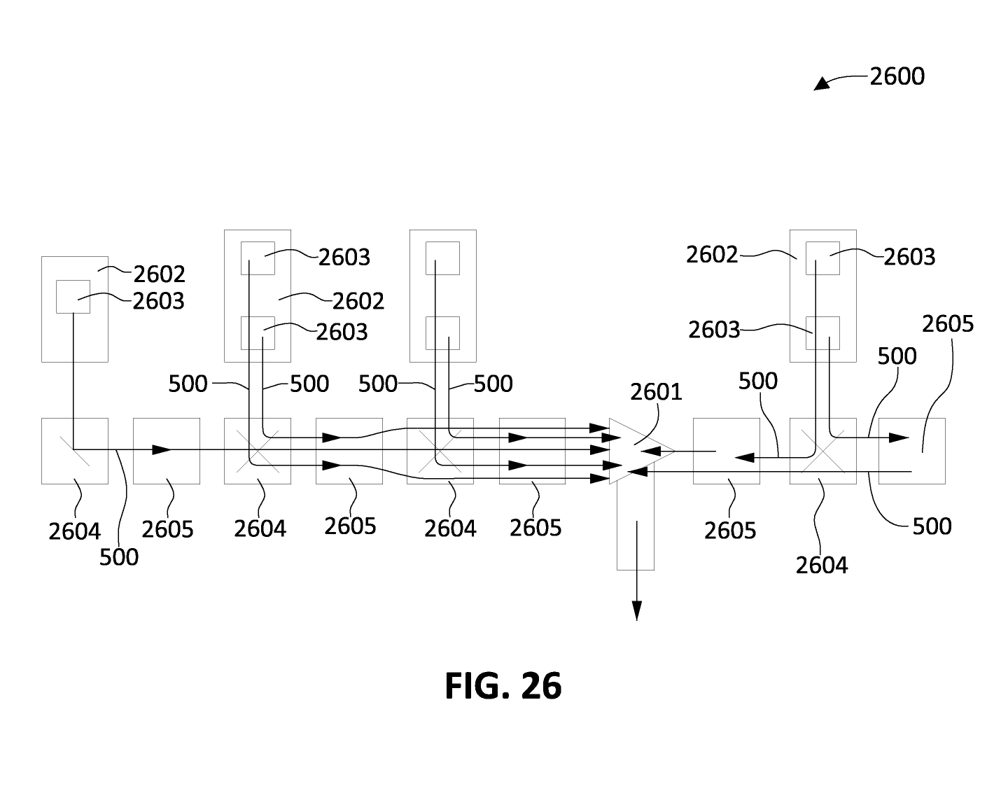

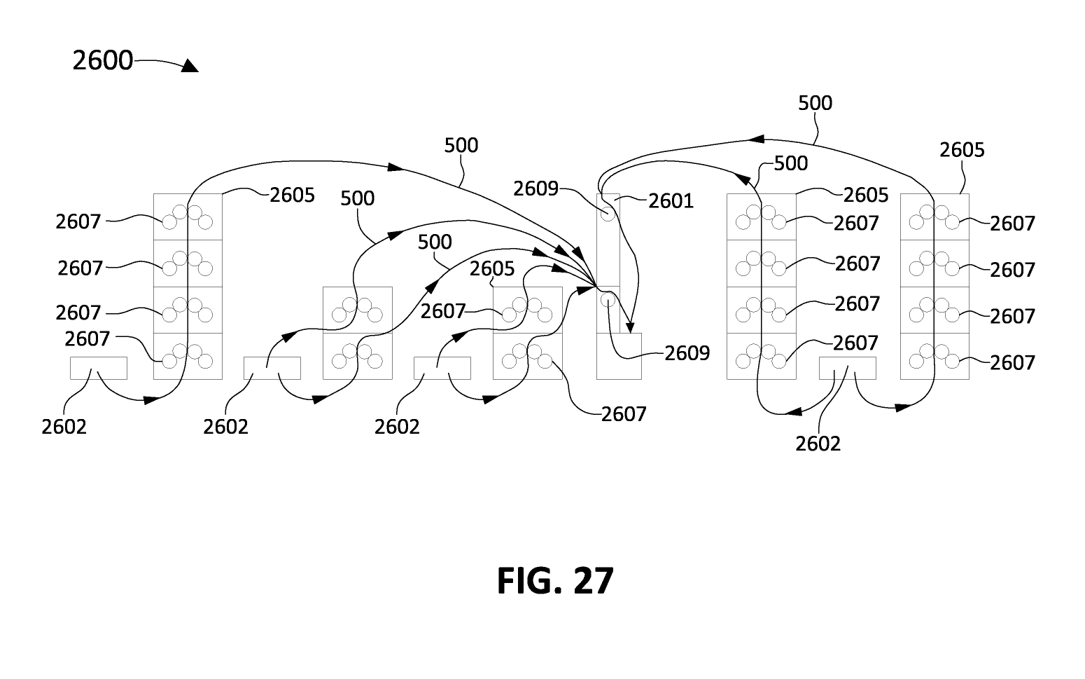

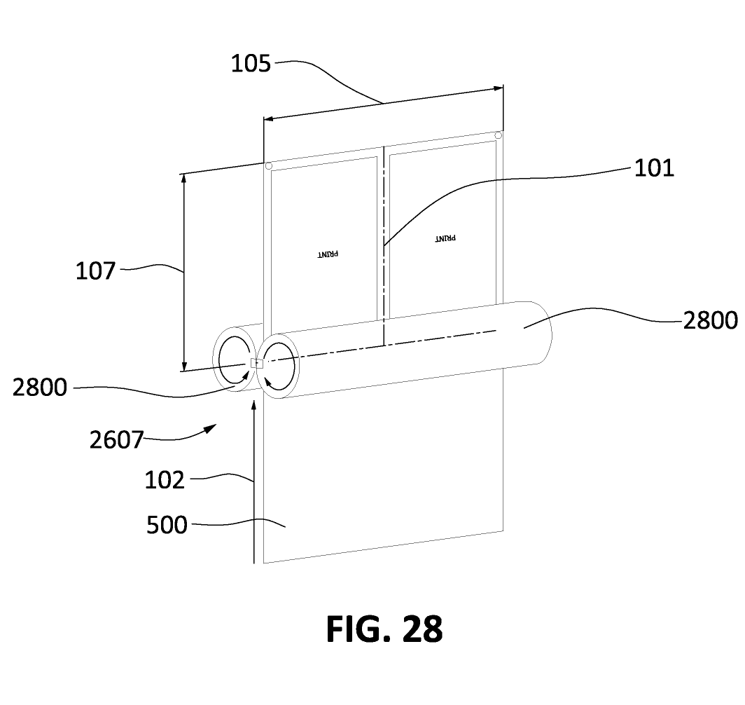

FIG. 26 shows a plan view of a conventional 2×1 press. FIG. 27 shows a side view of the 2×1 press shown in FIG. 26. In the example shown in FIGS. 26 and 27, the conventional 2×1 press is provided with a known folder 2601 having two formers 2609 for creating a half fold 101 (see FIGS. 1-2). The press includes three printing towers 2605 that receive paper from paper stands 2602, wherein paper rolls 2603 feed web 500 to paper guide units 2604. From the paper guide units 2604, the web 500 is fed to towers 2605. Each of the three printing towers 2605 include four printing units 2607 that print a single color on each side of the web, the two-high printing towers 2605 can each print a single color on each side of a web 500. FIG. 28 shows an exemplary printing arrangement on web 500 for the press shown with respect to FIGS. 26 and 27. As shown in FIG. 28, each of the printing units 2607 print 2 pages wide by 1 page around the circumference of printing drum 2800. So for each revolution of printing drum 2800, 4 pages are produced. With one web 500 per tower 2605 and one web 500 for each of the individual units 2607 in the printing units 2607 stacked two-high, this press arrangement 2600 is capable of producing a broadsheet product that has 12 pages of full color and 16 pages of black only in one or 2 sections. The broadsheet height is equal to the cutoff length 107 and would be 21 inches, 21½ inches, 22 inches or 22¾ inches depending on the fixed cutoff of the press arrangement 2600. The broadsheet width can vary between 10 inches and 18 inches depending on web width 105. 28 pages of broadsheet can be produced in one or 2 sections with 12 pages full color and 16 pages of black at a speed of 40,000 impressions/hr. Size of broadsheet 21½ inches tall×for example 11 inches-13 inches wide.

With one web 500 per tower 2605 and one web 500 for each of the individual units 2607 in the printing units 2607 stacked two-high, this press arrangement 2600 is capable of producing a tabloid product that has 24 pages of full color and 32 pages of black only in one large section. The tabloid size has a fixed width that is one half of the cutoff length 107 or 10½ inches, 10¾ inches, 11 inches or 11⅜ inches depending on the fixed cutoff of the press arrangement 2600. The height of the tabloid product is ½ of the web width and can vary from 10 inches-18 inches.

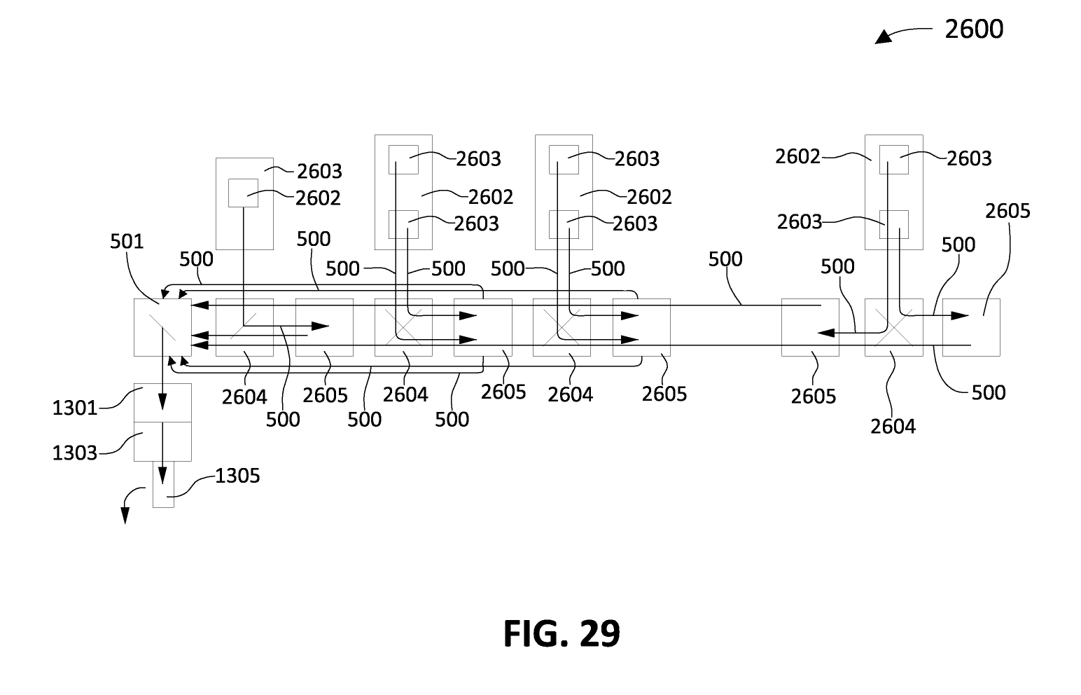

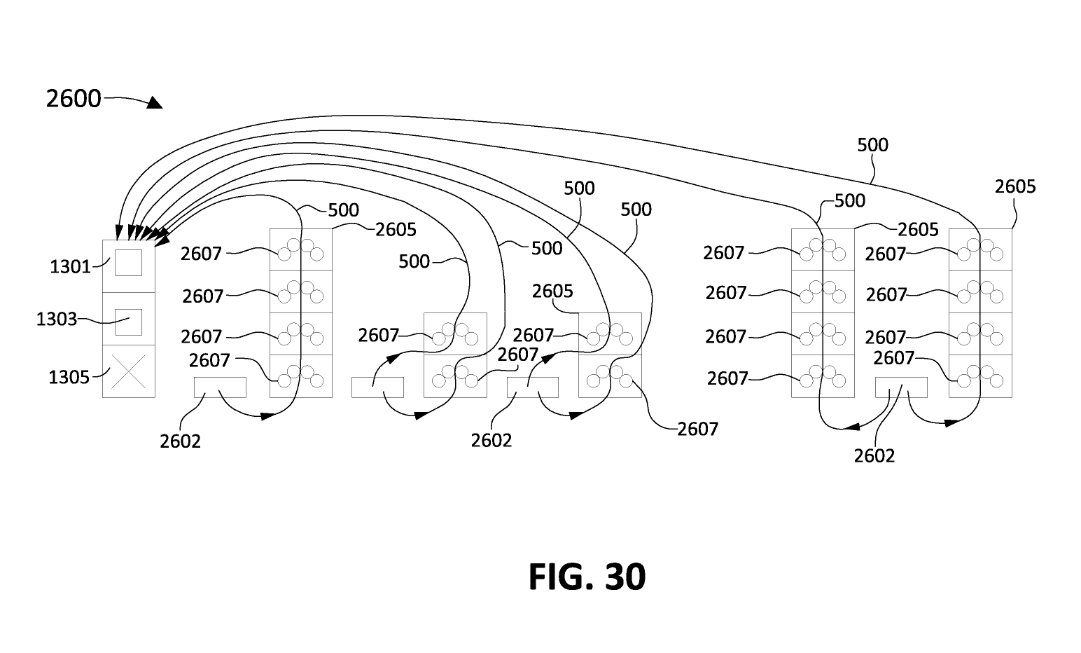

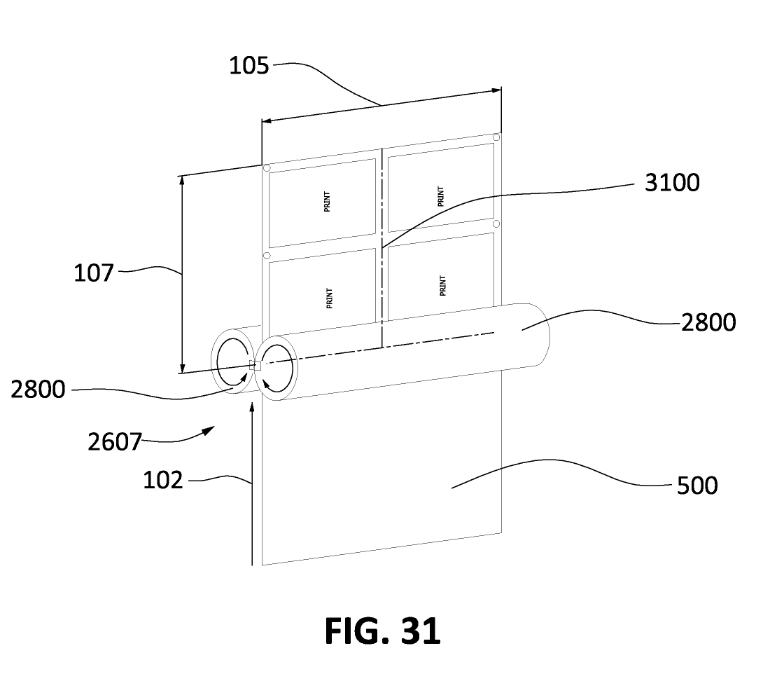

FIGS. 29 and 30 show a three tower 2605 printing press arrangement 2600 having two sets of printing units 2607 stacked two-high and a folder assembly according to an embodiment of the present disclosure. FIG. 29 shows a plan view of the 2×1 press. FIG. 30 shows a side view of the 2×1 press shown in FIG. 29. The arrangement of roll stands 2602, paper rolls 2603, paper guide units 2604, press towers 2605 and printing units 2607 are substantially the same as shown and described above with respect to FIGS. 26-27. However, the press arrangement 2600 of FIGS. 29 and 30 includes a folder assembly that includes a guide apparatus 501, a perpendicular half-page hold section 1301, a merge section 1303 and a quarter-page fold apparatus 1305. The web 500 is cut and folded by the guide apparatus 501, a perpendicular half-page hold section 1301, a merge section 1303 and a quarter-page fold apparatus 1305 to form a sectioned tabloid 800. That is, the embodiment shown in FIGS. 29 and 30 includes slitting the web 500 parallel to the direction of web travel 102 and printing in the opposite direction (i.e., perpendicular to the direction of web travel 102, which is also perpendicular to the printing direction of a broadsheet, which is shown in FIG. 31. As shown in FIG. 31, centerline of web 3100, corresponding to location of slitting by slitter 503 forms a ribbon width 509 corresponding to the height of each page. In addition, the cutoff length 107, which corresponds to eight pages of the sectioned tabloid 800, is printed with one circumference of the printing drum 2800. After slitting, the ribbons 504 are provided to the perpendicular half-page fold section 1301, which provides a fold perpendicular to the direction of web travel 102 and cuts the paper, while assembling the papers into sections. The paper sections are then merged and provided with a ¼ fold to produce a sectioned tabloid 800. A maximum of 56 pages can be produced to form sectioned tabloid 800 in 1, 2, 3, 4 or 5 sections with 24 pages full color and 32 pages of black at a speed of 40,000 impressions/hr. The size of sectioned tabloid 800 is 17½ inches-15 inches tall×10¾ inches wide.

The sectioned tabloid 800 provides paper savings over the broadsheet product, utilizing the same paper (i.e., same web 500) as utilized for broadsheet production. In addition, the same page count for the tabloid product may be produced without using the entire press, freeing up equipment and/or labor for other jobs. The cutting and folding system of the present disclosure permits a larger paper product than is produced with a broadsheet folding system with more sections while utilizing the same equipment. The cutting and folding system that includes the guide apparatus 501, a perpendicular half-page hold section 1301, a merge section 1303 and a quarter-page fold apparatus 1305 may be retrofit onto existing presses, without modification to the presses.

Retrofitting existing press arrangements involves providing webs on existing presses with an angle bar for slitting the web into ribbons. The folder for forming the sectioned tabloid 800 can be placed at 90 degrees to the existing pressline. The web slitting/angle bar section is inserted either at the end of the pressline or in place of an existing footprint, with ribbons turned 90 degrees. Single-around presses can double capacity with the tabloid format compared to a conventional broadsheet product, which more efficiently utilizes the footprint space of the press apparatus and folders. Drives could be mechanical or shaftless, depending on application.

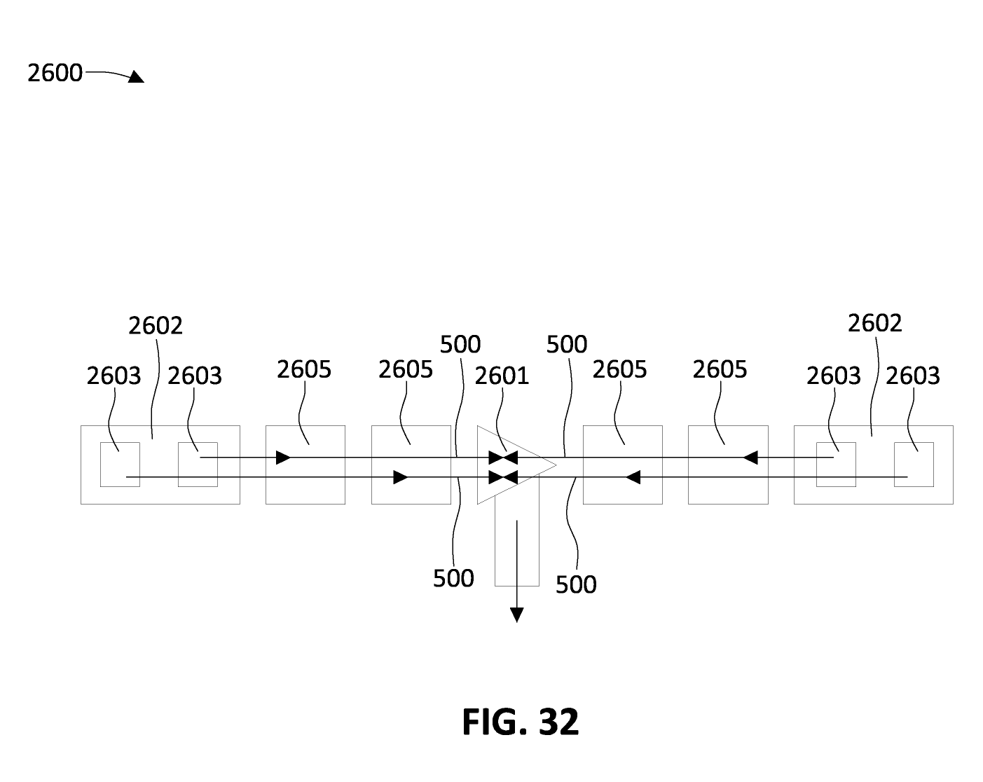

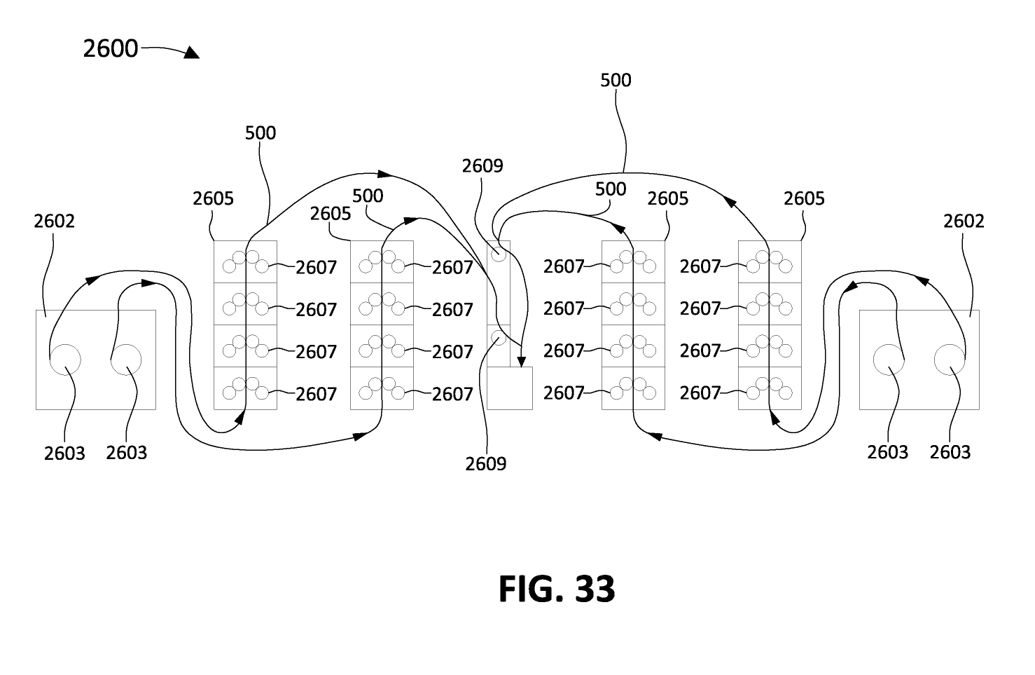

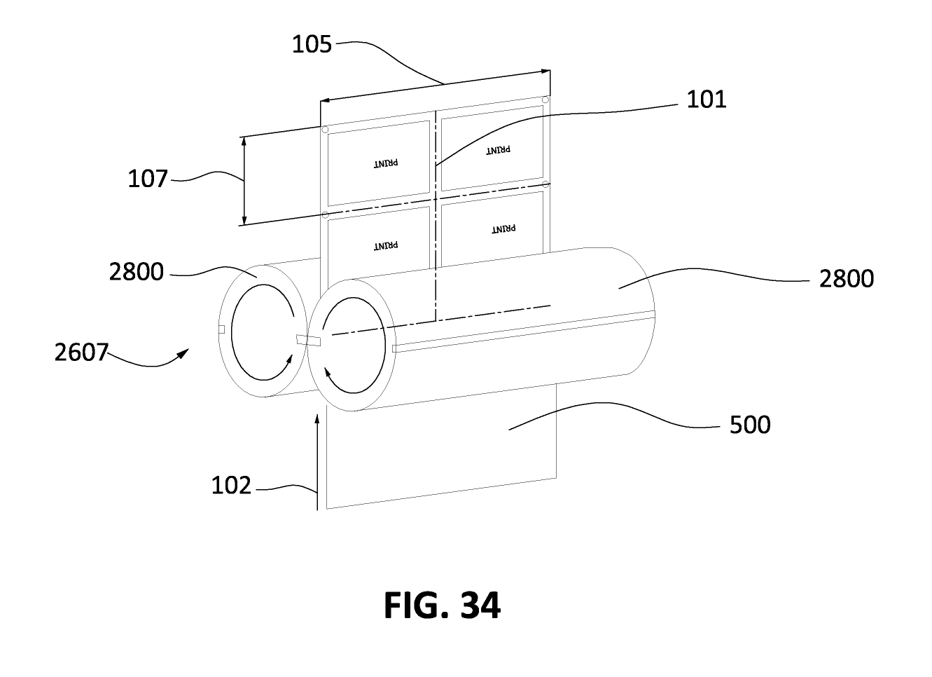

FIG. 32 shows a plan view of a conventional 2×2 press. FIG. 33 shows a side view of the 2×2 press shown in FIG. 32. In the examples shown in FIGS. 32 and 33, the conventional 2×2 press is provided with a known folder 2601 having two formers 2609 for creating a half-fold 103 (see FIGS. 1-2). The press includes four printing towers 2605 that receive paper from paper stands 2602, wherein paper rolls 2603 feed web 500 to printing towers 2605. Each printing tower 2605 consists of four printing units 2607 that print a single color on each side of the web 500 two pages wide by two pages around the circumference. As shown in FIG. 34, each of the printing units 2607 print 2 pages wide by 2 pages around the circumference of printing drum 2800. So for each revolution of printing drum 2800, eight pages of full color are produced.

With one web 500 per tower 2605, this press arrangement 2600 is capable of producing a 16 page full color broadsheet product 100 in either 1 or 2 sections running in straight mode. Or, if running in collect mode with the same number of webs 500 can produce a 32 page full color broadsheet product in either 2 or 4 sections. In collect mode however, half as many products are produced in a given period of time as running straight. For example, 16 pages straight at 50,000 impressions/hr would be 32 pages at 25,000 impressions/hr collect. The broadsheet size has a 21 inches, 21½ inches, 22 inches, or 22¾ inches height depending on the fixed cutoff of the press. The broadsheet width can vary between 10 inches and 18 inches depending on web width. Also, when running collect a two section product would have sections A & B. The same page count with a four section product sections A & C would have the same page count, and sections B & D would have the same page count, with a collect press having two formers 2609, a three section broadsheet product is not possible.

With one web 500 per tower 2605, the press arrangement 2600 is capable of producing a 32 page full color tabloid product in one section or, if running in collect mode with the same number of webs 500 can produce a 64 page full color tabloid product also in one section. However, half as many products are produced in a given period of time as running straight. For example, 32 pages straight at 50,000 impressions/hr would be 64 pages at 25,000 impressions/hr collect. The tabloid size has fixed width that is ½ of cutoff length or 10½ inches, 10¾ inches, 11 inches, or 11⅜ inches depending on the fixed cutoff of the press. The height of the tabloid product is ½ of the web width and can vary from 10 inches-18 inches.

A maximum of 32 pages can be produced to form a broadsheet in 2 or 4 sections all full color at a speed of 25,000 impressions/hr (collect). The size of the broadsheet is 21 inches tall×may be 11 inches-13 inches wide.

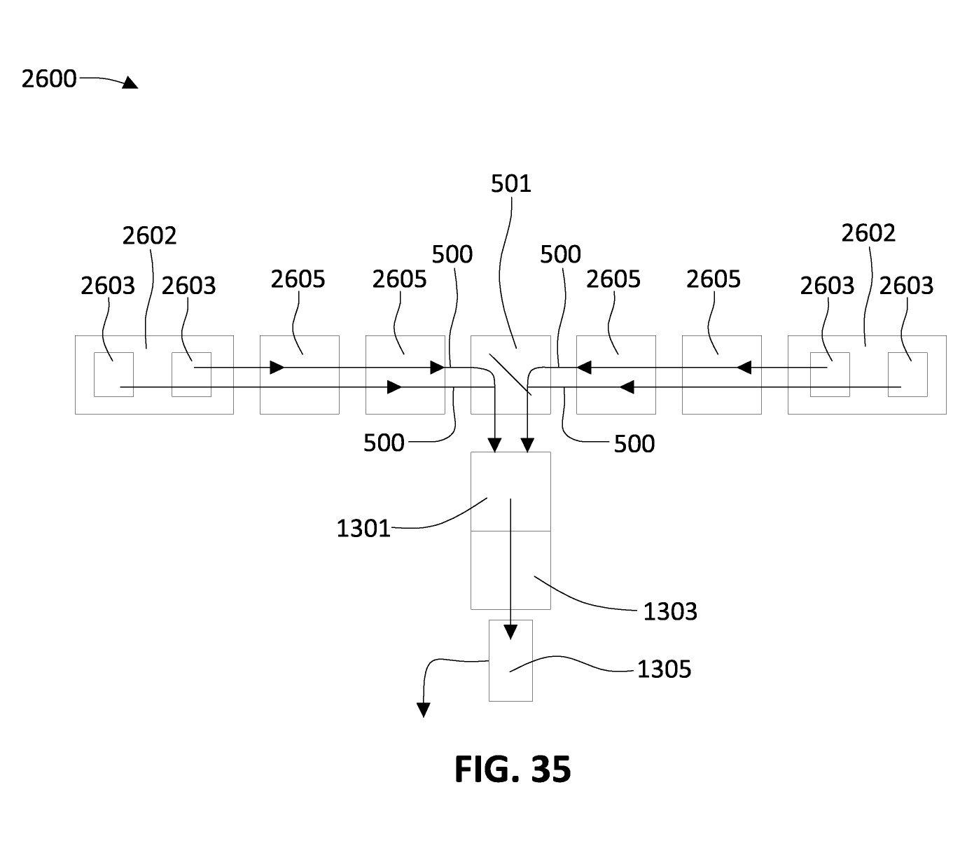

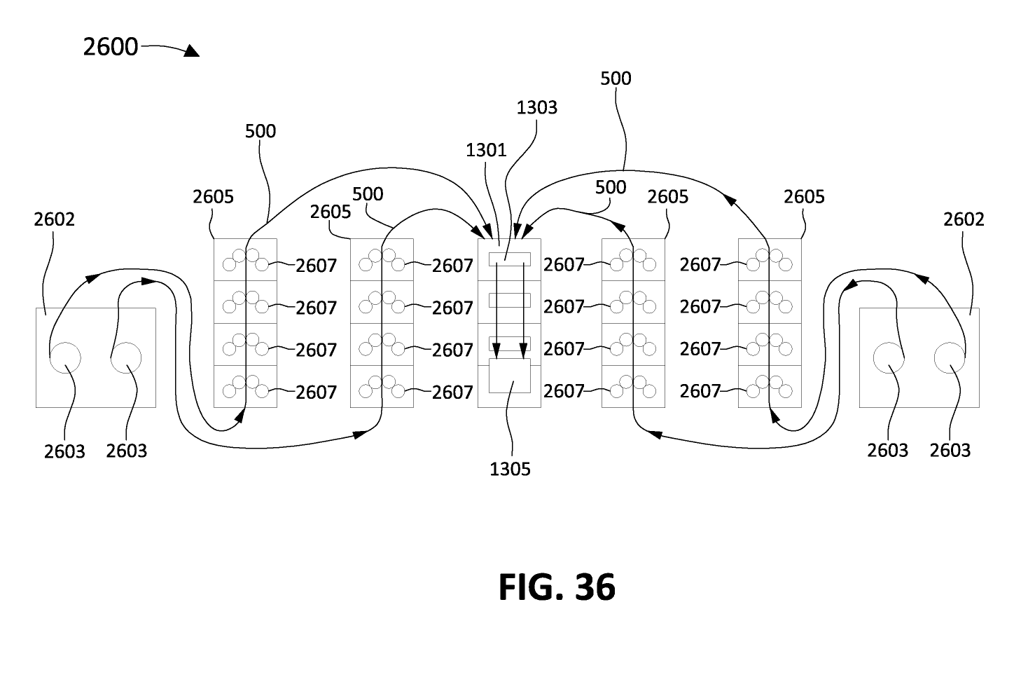

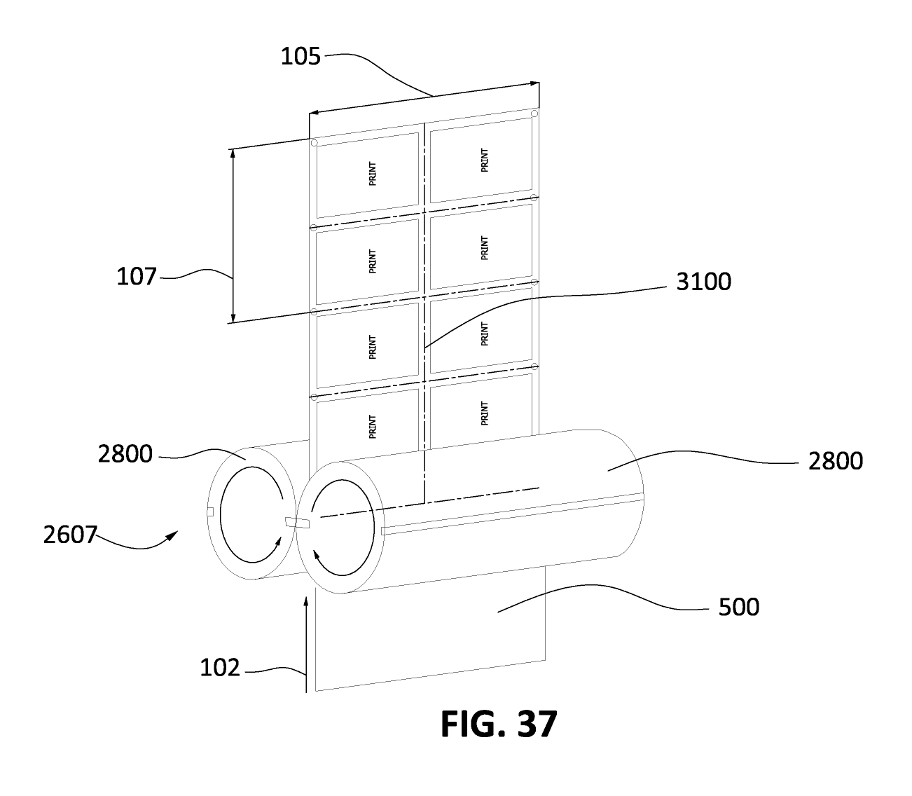

FIGS. 35 and 36 show a four tower 2605 printing press arrangement 2600 having four sets of printing units 2607 stacked four-high and a folder assembly according to an embodiment of the present disclosure. FIG. 35 shows a plan view of the 2×2 press. FIG. 36 shows a side view of the 2×2 press shown in FIG. 35. The arrangement of roll stands 2602, papers rolls 2603, paper guide units 2604, press towers 2605 and printing units 2607 are substantially the same as shown and described above with respect to FIGS. 32-33. However, the press arrangement 2600 of FIGS. 35 and 36 include a folder assembly that includes a guide apparatus 501, a perpendicular half-page hold section 1301, a merge section 1303 and a quarter-page fold apparatus 1305. The web 500 is cut and folded by the guide apparatus 501, a perpendicular half-page hold section 1301, a merge section 1303 and a quarter-page fold apparatus 1305 to form a sectioned tabloid 800. That is, the embodiments shown in FIGS. 35 and 36 include slitting the web 500 parallel to the direction of web travel 102 and printing in the opposite direction (i.e., perpendicular to the direction of web travel 102, which is also perpendicular to the printing direction of a broadsheet, which is shown in FIG. 37. As shown in FIG. 37, centerline of web 3100, corresponding to location of slitting by slitter 503 forms a ribbon width 509 corresponding to the height of each page. In addition, the cutoff length 107, which corresponds to eight pages of the sectioned tabloid 800, is printed with one half circumference of the printing drum 2800. One full circumference of the printing drum 2800 corresponds to 16 pages of the sectioned tabloid 800. After slitting, the ribbons 504 are provided to the perpendicular half-page fold section 1301, which provides a fold perpendicular to the direction of web travel 102 and cuts the paper, while assembling the papers into sections. The paper sections are then merged and provided with a quarter fold to produce a sectioned tabloid 800.

In certain embodiments, the cutting and folding system of the present disclosure can produce a sectioned tabloid 800 with up to 32 pages in 1, 2, 3, 4 or 5 sections all full color at a speed of 40,000-50,000 impressions/hr. The size of sectioned tabloid 800 is 18 inches-15 inches tall×10½ inches wide. The sectioned tabloid 800 provides paper savings over the broadsheet product, utilizing the same paper (i.e., same web 500). In addition, running the press in straight mode permits higher speeds and shorter runs, allowing for sell time on press for other jobs. The cutting and folding system that includes the guide apparatus 501, a perpendicular half-page hold section 1301, a merge section 1303 and a quarter-page fold apparatus 1305 may be retrofit onto existing presses, without modification to the presses.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A sectioned, folded tabloid paper product comprising:
a plurality of sections, the sections each having an independent number of pages;
a mechanically formed first fold perpendicular to web travel;
a mechanically formed second fold parallel to web travel; and
wherein the paper product comprises a tabloid format and is formed on press.

2. The paper product of claim 1, wherein the plurality of sections include sections having dissimilar page counts.

3. The paper product of claim 1, wherein the width of each page represents one half of a single cutoff length.

4. The paper product of claim 1, wherein the height of each page is a height selected from the group consisting of one half of a web width, one third of the web width and one fourth of the web width.

5. The paper product of claim 1, further comprising a lap that yields an above the fold front page.

6. The paper product of claim 1, further comprising pop-up ad inserts.

7. The paper product of claim 1, wherein the pages selectively include color printing.

8. An apparatus for forming a sectioned, folded tabloid paper product comprising:
a plurality of first folding devices arranged and disposed to fold the web perpendicular to web travel to form a tabloid section;
a merger arranged and disposed to collect the tabloid sections;
a quarter-page fold apparatus arranged and disposed to fold the collected tabloid sections to form a sectioned, folded tabloid paper product.

9. The apparatus of claim 8, further comprising a slitter to cut a web of paper parallel to a direction of web travel.

10. The apparatus of claim 8, wherein the first folding device is a jaw folder.

11. The apparatus of claim 10, wherein the jaw folder is a 1:2 jaw folder or a 2:2 jaw folder.

12. The apparatus of claim 11, wherein the jaw folder is a folder selected from the group consisting of a 1:3:3 jaw folder, a 1:2:2 jaw folder, a 2:3:3 jaw folder, and a 2:3:4 jaw folder.

13. The apparatus of claim 8, wherein the folding device is a rotary folder.

14. The apparatus of claim 8, wherein a plurality of mergers are arranged and disposed to collect tabloid sections.

15. The apparatus of claim 14, wherein the plurality of mergers are arranged in a substantially vertical orientation.

16. The apparatus of claim 14, wherein the plurality of mergers are arranged in a cascading diagonal orientation.

17. The apparatus of claim 14, wherein the plurality of mergers are arranged in a substantially horizontal orientation.

18. The apparatus of claim 8, wherein a guide apparatus includes the slitter.

19. The apparatus of claim 8, wherein a plurality of first folding devices are present.

20. The apparatus of claim 8, wherein a single merger collects the tabloid sections and provides the tabloid sections to the quarter fold apparatus.
